(19) United States
(12) Patent Application Publication
(10) Pub. No.: US 2017/0019678 A1
(43) Pub. Date: Jan. 19, 2017

(54) VIDEO COMPRESSION WITH COLOR SPACE SCALABILITY

(71) Applicant: Sharp Kabushiki Kaisha, Sakai-shi, Osaka (JP)

(72) Inventors: Seung-Hwan KIM, Camas, WA (US); Kiran MISRA, Camas, WA (US); Christopher A. SEGALL, Camas, WA (US)

(73) Assignee: Sharp Kabushiki Kaisha, Sakai City, Osaka (JP)

(21) Appl. No.: 15/124,388

(22) PCT Filed: Mar. 13, 2015
(86) PCT No.: PCT/US2015/020619

§ 371 Date: Sep. 8, 2016

Related U.S. Application Data
(60) Provisional application No. 61/953,139, filed on Mar. 14, 2014.

(51) Int. Cl. H04N 19/50; H04N 19/30

(52) U.S. Cl. CPC H04N 19/50; H04N 19/30; H04N 19/186

(57) ABSTRACT

An image decoder includes a base layer to decode at least a portion of an encoded video stream using a color space prediction technique.

### CROSS-REFERENCE TO RELATED APPLICATIONS

None.

### TECHNICAL FIELD

This disclosure relates generally to video coding, and, more particularly, to color space prediction for video coding.

### BACKGROUND OF THE INVENTION

Many systems include a video encoder to implement video coding standards and compress video data for transmission over a channel with limited bandwidth and/or limited storage capacity. These video coding standards can include multiple coding stages such as intra prediction, transform from spatial domain to frequency domain, inverse transform from frequency domain to spatial domain, quantization, entropy coding, motion estimation, and motion compensation, in order to more effectively encode frames.

Traditional digital High Definition (HD) content can be represented in a format described by video coding standard International Telecommunication Union Radio communication Sector (ITU-R) Recommendation BT.709, which defines a resolution, a color gamut, a gamma, and a quantization bit-depth for video content. With an emergence of higher resolution video standards, such as ITU-R Ultra High Definition Television (UHDTV), which, in addition to having a higher resolution, can have wider color gamut and increased quantization bit-depth compared to BT.709, many legacy systems based on lower resolution HD content may be unable to utilize compressed UHDTV content. One of the current solutions to maintain the usability of these legacy systems includes separately simulcasting both compressed HD content and compressed UHDTV content. Although a legacy system receiving the simulcasts has the ability to decode and utilize the compressed HD content, compressing and simulcasting multiple bitstreams with the same underlying content can be an inefficient use of processing, bandwidth, and storage resources.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a block diagram example of a video coding system.

FIG. 2 is an example graph 200 illustrating color gamuts supported in a BT.709 video standard and in a UHDTV video standard.

FIGS. 3A and 3B and 3C are block diagram examples of the video encoder shown in FIG. 1.

FIG. 4 is a block diagram example of the color space predictor shown in FIGS. 3A and 3B.

FIGS. 5A and 5B and 5C are block diagram examples of the video decoder shown in FIG. 1.

FIG. 6 is a block diagram example of a color space predictor shown in FIGS. 5A and 5B.

FIG. 7 is an example operational flowchart for color space prediction in the video encoder shown in FIG. 1.

FIG. 8 is an example operational flowchart for color space prediction in the video decoder shown in FIG. 1.

FIG. 9 is another example operational flowchart for color space prediction in the video decoder shown in FIG. 1.

FIG. 10 illustrates a 0th order Exponential Golomb code.

### DEFINITIONS

The following arithmetic operators are defined as follows:
+ Addition
− Subtraction (as a two-argument operator) or negation (as a unary prefix operator)
* Multiplication, including matrix multiplication
x^{y} Exponentiation. Specifies x to the power of y. In other contexts, such notation is used for superscripting not intended for interpretation as exponentiation.
/ Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.

$$\frac{x}{y}$$

Used to denote division in mathematical equations where no truncation or rounding is intended.

$${\sum }_{i = x}^{y} f ( i )$$

The summation of f(i) with i taking all integer values from x up to and including y.
x % y Modulus. Remainder of x divided by y, defined only for integers x and y with x >=0 and y>0.

The following logical operators are defined as follows:
x && y Boolean logical “and” of x and y.
x∥y Boolean logical “or” of x and y.
! Boolean logical “not”.
x?y:z If x is TRUE or not equal to 0, evaluates to the value of y; otherwise, evaluates to the value of z.

The following relational operators are defined as follows:
> Greater than.
>= Greater than or equal to.
<Less than.
<= Less than or equal to.
== Equal to.

!= Not equal to.

The following bit-wise operators are defined as follows:
& Bit-wise “and”. When operating on integer arguments, operates on a two's complement representation of the integer value. When operating on a binary argument that contains fewer bits than another argument, the shorter argument is extended by adding more significant bits equal to 0.
   | Bit-wise “or”. When operating on integer arguments, operates on a two's complement representation of the integer value. When operating on a binary argument that contains fewer bits than another argument, the shorter argument is extended by adding more significant bits equal to 0.
̂ Bit-wise “exclusive or”. When operating on integer arguments, operates on a two's complement representation of the integer value. When operating on a binary argument that contains fewer bits than another argument, the shorter argument is extended by adding more significant bits equal to 0.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

The following arithmetic operators are defined as follows:
= Assignment operator.
++ Increment, i.e. x++ is equivalent to x=x+1; when used in an array index, evaluates to the value of the variable prior to the increment operation.
−− Decrement, i.e. x−− is equivalent to x=x−1; when used in an array index, evaluates to the value of the variable prior to the decrement operation.
+= Increment by amount specified, i.e. x+=3 is equivalent to x=x+3, and x+=(−3) is equivalent to x=x+(−3).
−= Decrement by amount specified, i.e. x−=3 is equivalent to x=x−3, and x−=(−3) is equivalent to x=x−(−3).

The following mathematical functions are defined:

$$Abs ( x ) = \{ \begin{matrix}x ; & x >= 0 \\ - x ; & x < 0\end{matrix}$$

Ceil(x) the smallest integer greater than or equal to x

$$Clip {1}_{Y} ( x ) = Clip 3 ( 0 , ( 1 ≪ {BitDepth}_{Y} ) - 1 , x )$$

$$Clip {1}_{C} ( x ) = Clip 3 ( 0 , ( 1 ≪ {BitDepth}_{C} ) - 1 , x )$$

$$Clip 3 ( x , y , z ) = \{ \begin{matrix}x ; & z < x \\ y ; & z > y \\ z ; & otherwise\end{matrix}$$

Floor(x) the largest integer less than or equal to x.

$$Log 2 ( x ) the base \text{-} 2 logarithm of x . \\ Log 10 ( x ) the base \text{-} 10 logarithm of x . \\ Min ( x , y ) = \{ \begin{matrix}x ; & x <= y \\ y ; & x > y\end{matrix} \\ Max ( x , y ) = \{ \begin{matrix}x ; & x >= y \\ y ; & x < y\end{matrix} \\ Round ( x ) = Sign ( x ) * Floor ( Abs ( x ) + 0.5 ) \\ Sign ( x ) = \{ \begin{matrix}1 ; & x > 0 \\ 0 ; & x = 0 \\ - 1 ; & x < 0\end{matrix} \\ Sqrt ( x ) = \sqrt{x} \\ Swap ( x , y ) = ( y , x )$$

Exponential-Golomb code (i.e., EGk) is a parameterized structured code that codes non-negative integers, inclusive of zero. For a positive integer I, the kth order Exponential-Golomb code generates a binary codeword in the form,

EGₖ(I)=[(L′−1)zeros][Most significant (L−k) bits of β(I)+1][Last k bits of β(I)]=[(L′−1)zeros][β(1+I/2^{k})][Last k bits of β(I)],

where β(I) is the beta code of corresponds to the natural binary representation of I that interprets each binary word as a positive integer, L is the length of the binary codeword β(I), and L′ is the length of the binary codeword β(1+I/2^{k}), which corresponds to taking the first (L−k) bits of β(I) and arithmetically adding 1. The length L can be computed as L=([Log 2(I)]+1), for I>0, where [.] denotes rounding to the nearest smaller integer, where preferably I=0 and L=1. Similarly, the length L′ can be computed as L′=([Log 2(1+I/2^{k})]+1). A kth-order Exponential-Golomb code can be decoded by first reading and counting the leading 0 bits until 1 is reached. Let the number of counted 0's be N. The binary codeword β(I) is then obtained by reading the next N bits following the 1 bit, appending those read N bits to 1 in order to form a binary beta codeword, subtracting 1 from the formed binary codeword, and then reading and appending the last k bits. The obtained β(I) codeword is converted into its corresponding integer value I.

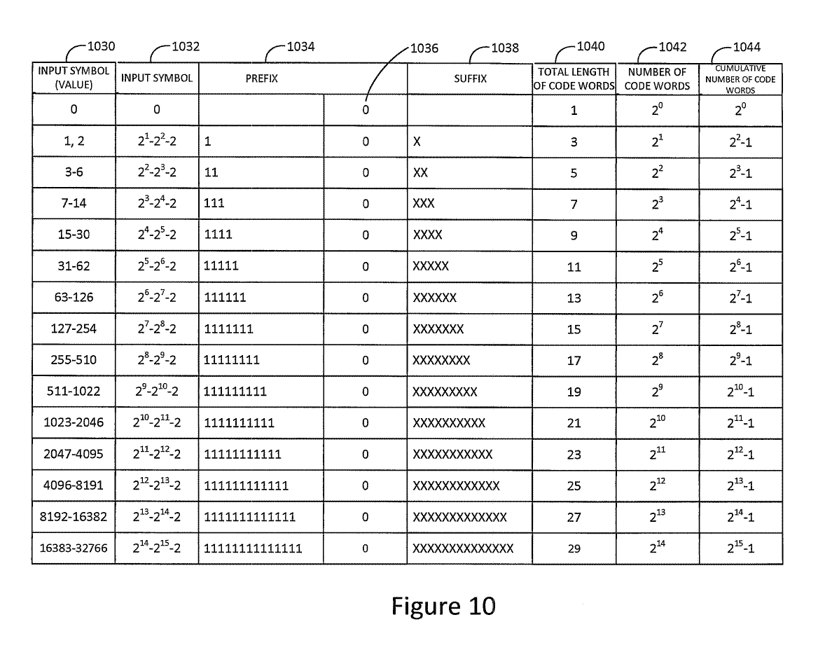

Referring to FIG. 10, an exemplary 0-th order Exponential-Golomb code is illustrated. A set of input values 1030 are determined. A corresponding set of input symbols 1032 are illustrated for the corresponding input values 1030. A prefix 1034 indicates the number of information bits corresponding to each input value, preferably coded with a series of “1” values. The flag column 1036, indicates the end of the number of information bits, and is preferably coded with a “0” value to distinguish it from the prefix bits 1034. A suffix column 1038 indicates the information bits indicating the input value. It is noted that the number of bits in the suffix 1038 is the same as the number of l's in the prefix 1034. The total length of the codewords 1040 indicates the corresponding total length of the corresponding code words, namely, the prefix 1034+the flag column 1036+the suffix 1038. A number of code words 1042 indicates the corresponding number of code words that may be represented for a prefix 1034, flag 1036 and suffix 1038 combination within a row of FIG. 10. A cumulative number of code words 1044 indicates the corresponding cumulative number of code words that may be represented using the prefix 1034, flag 1036 and suffix 1038 combination above (and including) a row of FIG. 10.

The following descriptors specify the parsing process of each syntax element:
ae(v): context-adaptive arithmetic entropy-coded syntax element.
b(8): byte having any pattern of bit string (8 bits). The parsing process for this descriptor is specified by the return value of the function read_bits(8).
f(n): fixed-pattern bit string using n bits written (from left to right) with the left bit first. The parsing process for this descriptor is specified by the return value of the function read_bits(n).
se(v): signed integer 0-th order Exp-Golomb-coded syntax element with the left bit first.
u(n): unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with most significant bit written first.
ue(v): unsigned integer 0-th order Exp-Golomb-coded syntax element with the left bit first.

### DETAILED DESCRIPTION OF PREFERRED EMBODIMENT

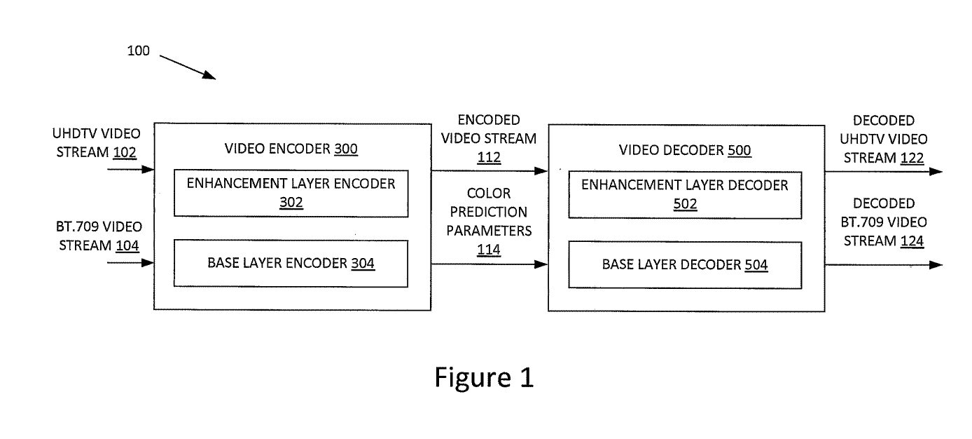

FIG. 1 is a block diagram example of a video coding system 100. The video coding system 100 can include a video encoder 300 to receive video streams, such as an Ultra High Definition Television (UHDTV) video stream 102, standardized as BT.2020, and a BT.709 video stream 104, and to generate an encoded video stream 112 based on the video streams. The video encoder 300 can transmit the encoded video stream 112 to a video decoder 500. The video decoder 500 can decode the encoded video stream 112 to generate a decoded UHDTV video stream 122 and/or a decoded BT.709 video stream 124.

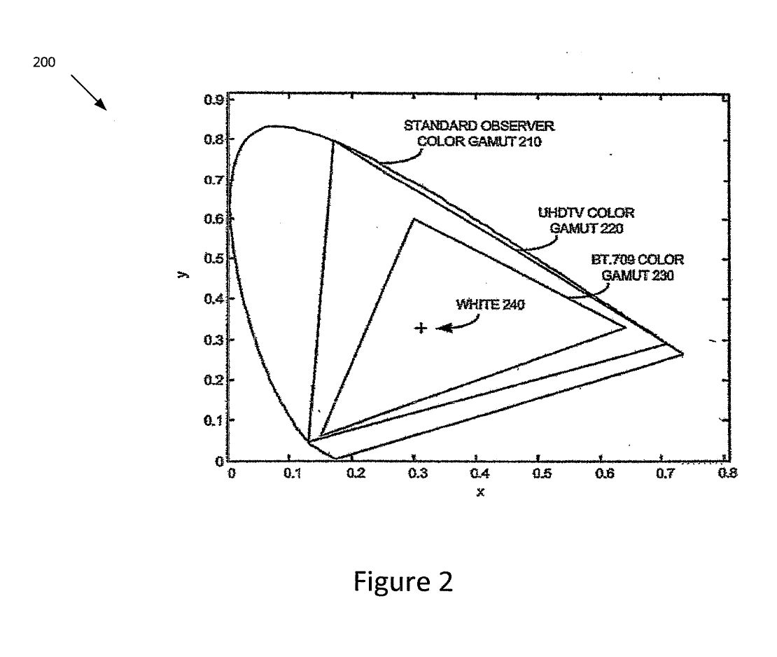

The UHDTV video stream 102 can have a different resolution, different quantization bit-depth, and represent different color gamut compared to the BT.709 video stream 104. For example, a UHDTV or BT.2020 video standard has a format recommendation that can support a 4 k (3840×2160 pixels) or an 8 k (7680×4320 pixels) resolution and a 10 or 12 bit quantization bit-depth. The BT.709 video standard has a format recommendation that can support a 2 k (1920×1080 pixels) resolution and an 8 or 10 bit quantization bit-depth. The UHDTV format recommendation also can support a wider color gamut than the BT.709 format recommendation. Embodiments of the color gamut difference between the UHDTV video standard and the BT.709 video standard will be shown and described below in greater detail with reference to FIG. 2.

The video encoder 300 can include an enhancement layer encoder 302 and a base layer encoder 304. The base layer encoder 304 can implement video encoding for High Definition (HD) content, for example, with a codec implementing a Moving Picture Experts Group (MPEG)-2 standard, or the like. The enhancement layer encoder 302 can implement video encoding for UHDTV content. In some embodiments, the enhancement layer encoder 302 can encode an UHDTV video frame by generating a prediction of at least a portion of the UHDTV image frame using a motion compensation prediction, an intra-frame prediction, and a scaled color prediction from a BT.709 image frame encoded in the base layer encoder 302. The video encoder 300 can utilize the prediction to generate a prediction residue, for example, a difference between the prediction and the UHDTV image frame, and encode the prediction residue in the encoded video stream 112.

In some embodiments, when the video encoder 300 utilizes a scaled color prediction from the BT.709 image frame, the video encoder 300 can transmit color prediction parameters 114 to the video decoder 500. The color prediction parameters 114 can include parameters utilized by the video encoder 300 to generate the scaled color prediction. For example, the video encoder 300 can generate the scaled color prediction through an independent color channel prediction or an affine matrix-based color prediction, each having different parameters, such as a gain parameter per channel or a gain parameter and an offset parameter per channel. The color prediction parameters 114 can include parameters corresponding to the independent color channel prediction or the affine matrix-based color prediction utilized by the video encoder 300. In some embodiments, the encoder 300 can include the color prediction parameters 114 in a normative portion of the encoded video stream 112, for example, in a Sequence Parameter Set (SPS), a Picture Parameter Set (PPS), or another lower level section of the normative portion of the encoded video stream 112. In some embodiments, the video encoder 300 can utilize default color prediction parameters 114, which may be preset in the video decoder 500, alleviating the video encoder 300 from having to transmit color prediction parameters 114 to the video decoder 500. Embodiments of video encoder 300 will be described below in greater detail.

The video decoder 500 can include an enhancement layer decoder 502 and a base layer decoder 504. The base layer decoder 504 can implement video decoding for High Definition (HD) content, for example, with a codec implementing a Moving Picture Experts Group (MPEG)-2 standard, or the like, and decode the encoded video stream 112 to generate a decoded BT.709 video stream 124. The enhancement layer decoder 502 can implement video decoding for UHDTV content and decode the encoded video stream 112 to generate a decoded UHDTV video stream 122.

In some embodiments, the enhancement layer decoder 502 can decode at least a portion of the encoded video stream 112 into the prediction residue of the UHDTV video frame. The enhancement layer decoder 502 can generate a same or a similar prediction of the UHDTV image frame that was generated by the video encoder 300 during the encoding process, and then combine the prediction with the prediction residue to generate the decoded UHDTV video stream 122. The enhancement layer decoder 502 can generate the prediction of the UHDTV image frame through motion compensation prediction, intra-frame prediction, or scaled color prediction from a BT.709 image frame decoded in the base layer decoder 504. Embodiments of video encoder 400 will be described below in greater detail.

Although FIG. 1 shows color prediction-based video coding of an UHDTV video stream and a BT.709 video stream with video encoder 300 and video decoder 500, in some embodiments, any video streams representing different color gamuts can be encoded or decoded with color prediction-based video coding.

FIG. 2 is an example graph 200 illustrating color gamuts supported in a BT.709 video standard and in a UHDTV video standard. Referring to FIG. 2, the graph 200 shows a two-dimensional representation of color gamuts in an International Commission on Illumination (CIE) 1931 chrominance xy diagram format. The graph 200 includes a standard observer color gamut 210 to represent a range of colors viewable by a standard human observer as determined by the CIE in 1931. The graph 200 includes a UHDTV color gamut 220 to represent a range of colors supported by the UHDTV video standard. The graph 200 includes a BT.709 color gamut 230 to represent a range of colors supported by the BT.709 video standard, which is narrower than the UHDTV color gamut 220. The graph also includes a point that represents the color white 240, which is included in the standard observer color gamut 210, the UHDTV color gamut 220, and the BT.709 color gamut 230.

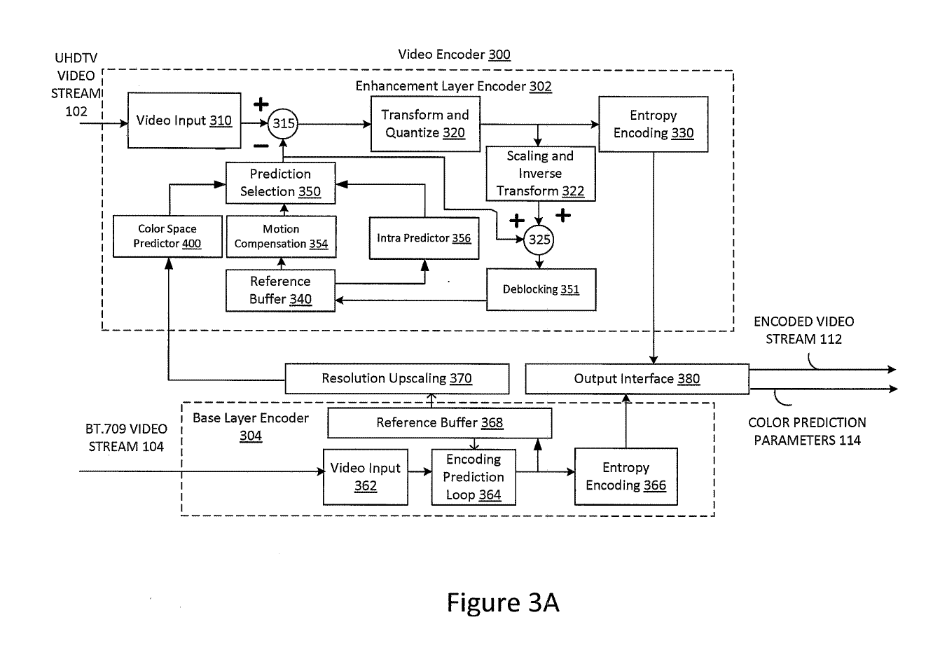

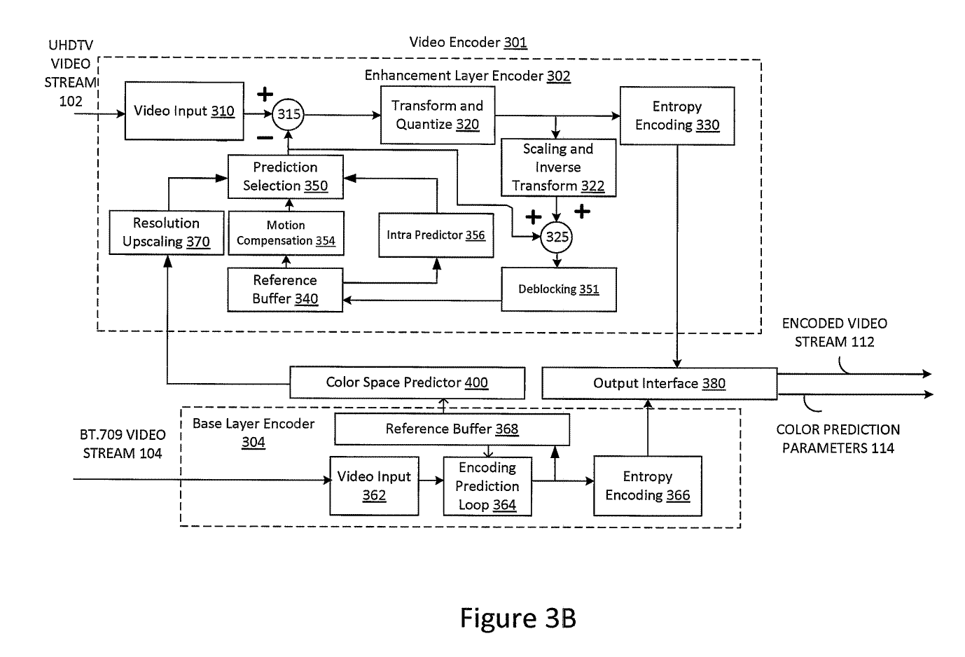

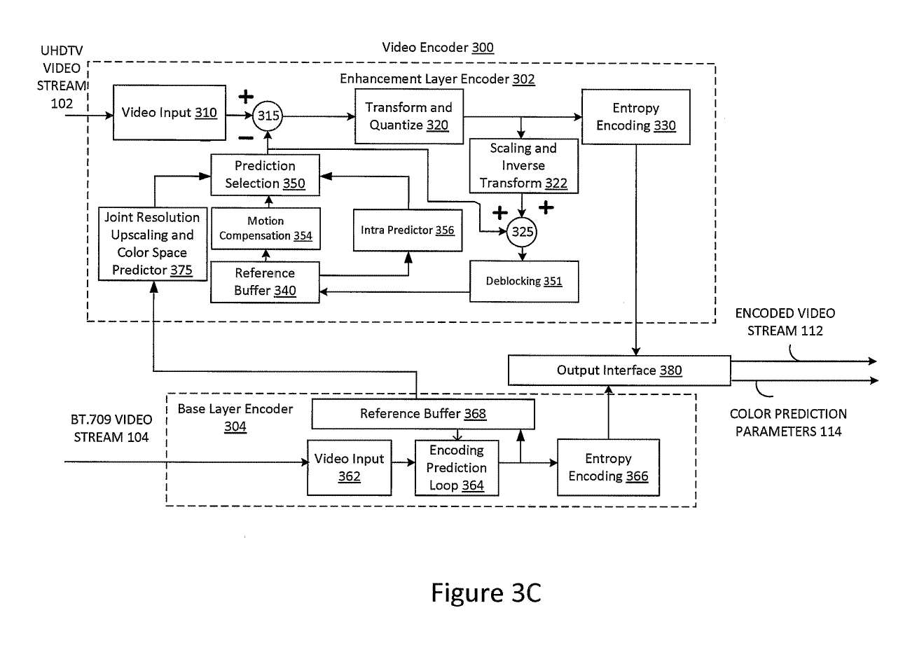

FIGS. 3A and 3B and 3C are block diagram examples of the video encoder 300 shown in FIG. 1. It is to be understood that any suitable type of video encoder may be used for any suitable type of video content. It is to be understood that any suitable type of video decoder may be used for any suitable type of video content. It is also to be understood that the video content may be in any format desired. Also, it is to be understood that the base layer and the enhancement layer may be any type of layers, and do not necessarily refer to a lower and a higher resolution image. In addition, the base layer may be high efficiency video coding (HEVC) compliant, if desired. In addition, the enhancement layers may be Scalable extension of HEVC (SHVC) and Multi-view extension of HEVC (MV-HEVC) complaint, if desired. HEVC specification may include, B. Bross, W-J. Han, J-R Ohm, G. J. Sullivan, and T. Wiegand, “High efficiency video coding (HEVC) text specification draft 10”, JCTVC-L1003, Geneva, January 2013, incorporated by reference herein in its entirety; a multi-view specification may include, G. Tech, K. Wegner, Y. Chen, M. Hannuksela, J. Boyce, “MV-HEVC Draft Text 6 (ISO/IEC 23008-2:201x/PDAM2)”, JCT3V-F1004, Geneva, November, 2013, incorporated by reference herein in its entirety; a multi-view specification may include, G. Tech, K. Wegner, Y. Chen, M. Hannuksela, J. Boyce, “MV-IJEVC Draft Text 7”, JCT3V-01004, San Jose, January 2014, incorporated by reference herein in its entirety; the scalable specification may include, J. Chen, J. Boyce, Y. Ye, M. Hannuksela, “SHVC Draft 4”, JCTVC-01008, Geneva, November 2013 incorporated by reference herein in its entirety; the scalable specification may include, J. Chen, J. Boyce, Y. Ye, M. Hannuksela, Y. K. Wang, “High Efficiency Video Coding (HEVC) Scalable Extension Draft 5”, JCTVC-P1008, San Jose, January 2014, incorporated by reference herein in its entirety.

Referring to FIG. 3A, the video encoder 300 can include an enhancement layer encoder 302 and a base layer encoder 304. The base layer encoder 304 can include a video input 362 to receive a BT.709 video stream 104 having HD image frames. The base layer encoder 304 can include an encoding prediction loop 364 to encode the BT.709 video stream 104 received from the video input 362, and store the reconstructed frames of the BT.709 video stream in a reference buffer 368. The reference buffer 368 can provide the reconstructed BT.709 image frames back to the encoding prediction loop 364 for use in encoding other portions of the same frame or other frames of the BT.709 video stream 104. The reference buffer 368 can store the image frames encoded by the encoding prediction loop 364. The base layer encoder 304 can include entropy encoding function 366 to perform entropy encoding operations on the encoded-version of the BT.709 video stream from the encoding prediction loop 364 and provide an entropy encoded stream to an output interface 380.

The enhancement layer encoder 302 can include a video input 310 to receive a UHDTV video stream 102 having UHDTV image frames. The enhancement layer encoder 302 can generate a prediction of the UHDTV image frames and utilize the prediction to generate a prediction residue, for example, a difference between the prediction and the UHDTV image frames determined with a combination function 315. In some embodiments, the combination function 315 can include weighting, such as linear weighting, to generate the prediction residue from the prediction of the UHDTV image frames. The enhancement layer encoder 302 can transform and quantize the prediction residue with a transform and quantize function 320. An entropy encoding function 330 can encode the output of the transform and quantize function 320, and provide an entropy encoded stream to the output interface 380. The output interface 380 can multiplex the entropy encoded streams from the entropy encoding functions 366 and 330 to generate the encoded video stream 112.

The enhancement layer encoder 302 can include a color space predictor 400, a motion compensation prediction function 354, and an intra predictor 356, each of which can generate a prediction of the UHDTV image frames. The enhancement layer encoder 302 can include a prediction selection function 350 to select a prediction generated by the color space predictor 400, the motion compensation prediction function 354, and/or the intra predictor 356 to provide to the combination function 315.

In some embodiments, the motion compensation prediction function 354 and the intra predictor 356 can generate their respective predictions based on UHDTV image frames having previously been encoded and decoded by the enhancement layer encoder 302. For example, after a prediction residue has been transformed and quantized, the transform and quantize function 320 can provide the transformed and quantized prediction residue to a scaling and inverse transform function 322, the result of which can be combined in a combination function 325 with the prediction utilized to generate the prediction residue and generate a decoded UHDTV image frame. The combination function 325 can provide the decoded UHDTV image frame to a deblocking function 351, and the deblocking function 351 can store the decoded UHDTV image frame in a reference buffer 340, which holds the decoded UHDTV image frame for use by the motion compensation prediction function 354 and the intra predictor 356. In some embodiments, the deblocking function 351 can filter the decoded UHDTV image frame, for example, to smooth sharp edges in the image between macroblocks corresponding to the decoded UHDTV image frame.

The motion compensation prediction function 354 can receive one or more decoded UHDTV image frames from the reference buffer 340. The motion compensation prediction function 354 can generate a prediction of a current UHDTV image frame based on image motion between the one or more decoded UHDTV image frames from the reference buffer 340 and the UHDTV image frame.

The intra predictor 356 can receive a first portion of a current UHDTV image frame from the reference buffer 340. The intra predictor 356 can generate a prediction corresponding to a first portion of a current UHDTV image frame based on at least a second portion of the current UHDTV image frame having previously been encoded and decoded by the enhancement layer encoder 302.

The color space predictor 400 can generate a prediction of the UHDTV image frames based on BT.709 image frames having previously been encoded by the base layer encoder 304. In some embodiments, the reference buffer 368 in the base layer encoder 304 can provide the reconstructed BT.709 image frame to a resolution upscaling function 370, which can scale the resolution of the reconstructed BT.709 image frame to a resolution that corresponds to the UHDTV video stream 102. The resolution upscaling function 370 can provide an upscaled resolution version of the reconstructed BT.709 image frame to the color space predictor 400. The color space predictor can generate a prediction of the UHDTV image frame based on the upscaled resolution version of the reconstructed BT.709 image frame. In some embodiments, the color space predictor 400 can scale a YUV color space of the upscaled resolution version of the reconstructed BT.709 image frame to correspond to the YUV representation supported by the UHDTV video stream 102. In some embodiments, the upscaling and color prediction are done jointly. The reference buffer 368 in the base layer encoder 304 can provide reconstructed BT.709 images frames to the joint upscaler color predictor. The joint upscaler color predictor 375 generates an upscaled and color prediction of the UHDTV image frame. The combined upscaler and color prediction functions enable reduced complexity as well as avoiding loss of precision resulting from limited bit-depth between the separate upscaler and the color prediction modules.

There are several ways for the color space predictor 400 to scale the color space supported by BT.709 video coding standard to a color space supported by the UHDTV video stream 102, such as independent channel prediction and affine mixed channel prediction. Independent channel prediction can include converting each portion of the YUV color space for the BT.709 image frame separately into the prediction of the UHDTV image frame. The Y portion or luminance can be scaled according to Equation 1:

Y_{UHDTV}=g₁·Y_{BT.709}+o₁

The U portion or one of the chrominance portions can be scaled according to Equation 2:

U_{UHDTV}=g₂·U_{BT.709}+o₂

The V portion or one of the chrominance portions can be scaled according to Equation 3:

V_{UHDTV}=g₃·V_{BT.709}+o₃

The gain parameters g1, g2, and g3 and the offset parameters o1, o2, and o3 can be based on differences in the color space supported by the BT.709 video coding standard and the UHDTV video standard, and may vary depending on the content of the respective BT.709 image frame and UHDTV image frame. The enhancement layer encoder 304 can output the gain parameters g1, g2, and g3 and the offset parameters o1, o2, and o3 utilized by the color space predictor 400 to generate the prediction of the UHDTV image frame to the video decoder 500 as the color prediction parameters 114, for example, via the output interface 380.

In some embodiments, the independent channel prediction can include gain parameters g1, g2, and g3, and zero parameters. The Y portion or luminance can be scaled according to Equation 4:

Y_{UHDTV}=g₁·(Y_{BT.709}−Yzero_{BT.709})+Yzero_{UHDTV}

The U portion or one of the chrominance portions can be scaled according to Equation 5:

U_{UHDTV}=g₂·(U_{BT.709}−Uzero_{BT.709})+Uzero_{UHDTV}

The V portion or one of the chrominance portions can be scaled according to Equation 6:

V_{UHDTV}=g₂·(V_{BT.709}−Vzero_{BT.709})+Vzero_{UHDTV}

The gain parameters g1, g2, and g3 can be based on differences in the color space supported by the BT.709 video coding standard and the UHDTV video standard, and may vary depending on the content of the respective BT.709 image frame and UHDTV image frame. The enhancement layer encoder 304 can output the gain parameters g1, g2, and g3 utilized by the color space predictor 400 to generate the prediction of the UHDTV image frame to the video decoder 500 as the color prediction parameters 114, for example, via the output interface 380. Since the video decoder 500 can be pre-loaded with the zero parameters, the video encoder 300 can generate and transmit fewer color prediction parameters 114, for example, three instead of six, to the video decoder 500.

In some embodiments, the zero parameters used in Equations 4-6 can be defined based on the bit-depth of the relevant color space and color channel. For example, in Table 1, the zero parameters can be defined as follows:

TABLE 1

| | |
|---|---|
| Yzero_{BT.709} = 0 | Yzero_{UHDTV} = 0 |
| Uzero_{BT.709} = (1 << bits_{BT.709}) | Uzero_{UHDTV} = (1 << bits_{UHDTV}) |
| Vzero_{BT.709} = (1 << bits_{BT.709}) | Vzero_{UHDTV} = (1 << bits_{UHDTV}) |

The affine mixed channel prediction can include converting the YUV color space for a BT.709 image frame by mixing the YUV channels of the BT.709 image frame to generate a prediction of the UHDTV image frame, for example, through a matrix multiplication function. In some embodiments, the color space of the BT.709 can be scaled according to Equation 7:

$${( \begin{matrix}Y \\ U \\ V\end{matrix} )}_{UHDTV} = ( \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ) \cdot {( \begin{matrix}Y \\ U \\ V\end{matrix} )}_{BT .709} + ( \begin{matrix}{o}_{1} \\ {o}_{2} \\ {o}_{3}\end{matrix} )$$

The matrix parameters m11, m12, m13, m21, m22, m23, m31, m32, and m33 and the offset parameters o1, o2, and o3 can be based on the difference in color space supported by the BT.709 video format recommendation and the UHDTV video format recommendation, and may vary depending on the content of the respective BT.709 image frame and UHDTV image frame. The enhancement layer encoder 304 can output the matrix and offset parameters utilized by the color space predictor 400 to generate the prediction of the UHDTV image frame to the video decoder 500 as the color prediction parameters 114, for example, via the output interface 380.

In some embodiments, the color space of the BT.709 can be scaled according to Equation 8:

$${( \begin{matrix}Y \\ U \\ V\end{matrix} )}_{UHDTV} = ( \begin{matrix}{m}_{11} & {m}_{12} & {m}_{13} \\ 0 & {m}_{22} & 0 \\ 0 & 0 & {m}_{33}\end{matrix} ) \cdot {( \begin{matrix}Y \\ U \\ V\end{matrix} )}_{BT .709} + ( \begin{matrix}{o}_{1} \\ {o}_{2} \\ {o}_{3}\end{matrix} )$$

The matrix parameters m11, m12, m13, m22, and m33 and the offset parameters o1, o2, and o3 can be based on the difference in color space supported by the BT.709 video coding standard and the UHDTV video standard, and may vary depending on the content of the respective BT.709 image frame and UHDTV image frame. The enhancement layer encoder 304 can output the matrix and offset parameters utilized by the color space predictor 400 to generate the prediction of the UHDTV image frame to the video decoder 500 as the color prediction parameters 114, for example, via the output interface 380.

By replacing the matrix parameters m21, m23, m31, and m32 with zero, the luminance channel Y of the UHDTV image frame prediction can be mixed with the color channels U and V of the BT.709 image frame, but the color channels U and V of the UHDTV image frame prediction may not be mixed with the luminance channel Y of the BT.709 image frame. The selective channel mixing can allow for a more accurate prediction of the luminance channel UHDTV image frame prediction, while reducing a number of prediction parameters 114 to transmit to the video decoder 500.

In some embodiments, the color space of the BT.709 can be scaled according to Equation 9:

$${( \begin{matrix}Y \\ U \\ V\end{matrix} )}_{UHDTV} = ( \begin{matrix}{m}_{11} & {m}_{12} & {m}_{13} \\ 0 & {m}_{22} & {m}_{23} \\ 0 & {m}_{32} & {m}_{33}\end{matrix} ) \cdot {( \begin{matrix}Y \\ U \\ V\end{matrix} )}_{BT .709} + ( \begin{matrix}{o}_{1} \\ {o}_{2} \\ {o}_{3}\end{matrix} )$$

The matrix parameters m11, m12, m13, m22, m23, m32, and m33 and the offset parameters o1, o2, and o3 can be based on the difference in color space supported by the BT.709 video standard and the UHDTV video standard, and may vary depending on the content of the respective BT.709 image frame and UHDTV image frame. The enhancement layer encoder 304 can output the matrix and offset parameters utilized by the color space predictor 400 to generate the prediction of the UHDTV image frame to the video decoder 500 as the color prediction parameters 114, for example, via the output interface 380.

By replacing the matrix parameters m21 and m31 with zero, the luminance channel Y of the UHDTV image frame prediction can be mixed with the color channels U and V of the BT.709 image frame. The U and V color channels of the UHDTV image frame prediction can be mixed with the U and V color channels of the BT.709 image frame, but not the luminance channel Y of the BT.709 image frame. The selective channel mixing can allow for a more accurate prediction of the luminance channel UHDTV image frame prediction, while reducing a number of prediction parameters 114 to transmit to the video decoder 500,

The color space predictor 400 can generate the scaled color space predictions for the prediction selection function 350 on a per sequence (inter-frame), a per frame, or a per slice (intra-frame) basis, and the video encoder 300 can transmit the prediction parameter 114 corresponding to the scaled color space predictions on a per sequence (inter-frame), a per frame, or a per slice (intra-frame) basis. In some embodiments, the granularity for generating the scaled color space predictions can be preset or fixed in the color space predictor 400 or dynamically adjustable by the video encoder 300 based on encoding function or the content of the UHDTV image frames.

The video encoder 300 can transmit the color prediction parameters 114 in a normative portion of the encoded video stream 112, for example, in a Sequence Parameter Set (SPS), a Picture Parameter Set (PPS), or another lower level section of the normative portion of the encoded video stream 112. In some embodiments, the color prediction parameters 114 can be inserted into the encoded video stream 112 with a syntax that allows the video decoder 500 to identify that the color prediction parameters 114 are present in the encoded video stream 112, to identify a precision or size of the parameters, such as a number of bits utilized to represent each parameter, and identify a type of color space prediction the color space predictor 400 of the video encoder 300 utilized to generate the color space prediction.

In some embodiments, the normative portion of the encoded video stream 112 can include a flag (use_color_space_prediction), for example, one or more bits, which can annunciate an inclusion of color space parameters 114 in the encoded video stream 112. The normative portion of the encoded video stream 112 can include a size parameter (color_predictor_num_fraction_bits_minus1), for example, one or more bits, which can identify a number of bits or precision utilized to represent each parameter. The normative portion of the encoded video stream 112 can include a predictor type parameter (color_predictor_idc), for example, one or more bits, which can identify a type of color space prediction utilized by the video encoder 300 to generate the color space prediction. The types of color space prediction can include independent channel prediction, affine prediction, their various implementations, or the like. The color prediction parameters 114 can include gain parameters, offset parameters, and/or matrix parameters depending on the type of prediction utilized by the video encoder 300.

Referring to FIG. 3B, a video encoder 301 can be similar to video encoder 300 shown and described above in FIG. 3A with the following differences. The video encoder 301 can switch the color space predictor 400 with the resolution upscaling function 370. The color space predictor 400 can generate a prediction of the UHDTV image frames based on BT.709 image frames having previously been encoded by the base layer encoder 304.

In some embodiments, the reference buffer 368 in the base layer encoder 304 can provide the encoded BT.709 image frame to the color space predictor 400. The color space predictor can scale a YUV color space of the encoded BT.709 image frame to correspond to the YUV representation supported by the UHDTV video format. The color space predictor 400 can provide the color space prediction to a resolution upscaling function 370, which can scale the resolution of the color space prediction of the encoded BT.709 image frame to a resolution that corresponds to the UHDTV video format. The resolution upscaling function 370 can provide a resolution upscaled color space prediction to the prediction selection function 350.

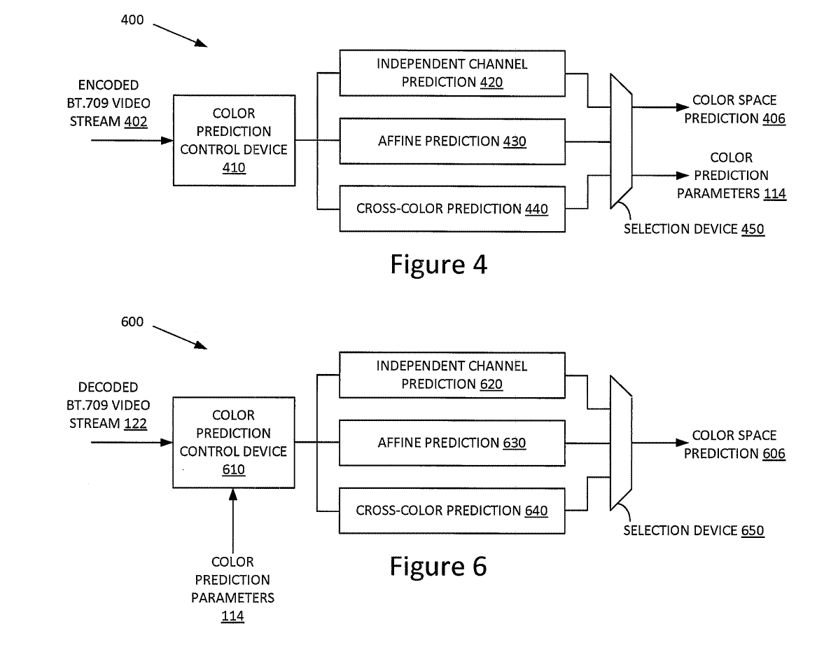

FIG. 4 is a block diagram example of the color space predictor 400 shown in FIG. 3A. Referring to FIG. 4, the color space predictor 400 can include a color space prediction control device 410 to receive a reconstructed BT.709 video frame 402, for example, from a base layer encoder 304 via a resolution upscaling function 370, and select a prediction type and timing for a generation for a color space prediction 406. In some embodiments, the color space prediction control device 410 can pass the reconstructed BT.709 video frame 402 to at least one of an independent channel prediction function 420, an affine prediction function 430, or a cross-color prediction function 440. Each of the prediction functions 420, 430, and 440 can generate a color space prediction of a UHDTV image frame (or portion thereof) from the reconstructed BT.709 video frame 402, for example, by scaling the color space of a BT.709 image frame to a color space of the UHDTV image frame.

The independent color channel prediction function 420 can scale YUV components of the encoded BT.709 video stream 402 separately, for example, as shown above in Equations 1-6. The affine prediction function 430 can scale YUV components of the reconstructed BT.709 video frame 402 with a matrix multiplication, for example, as shown above in Equation 7. The cross-color prediction function 440 can scale YUV components of the encoded BT.709 video stream 402 with a modified matrix multiplication that can eliminate mixing of a Y component from the encoded BT.709 video stream 402 when generating the U and V components of the UHDTV image frame, for example, as shown above in Equations 8 or 9.

In some embodiments, the color space predictor 400 can include a selection device 450 to select an output from the independent color channel prediction function 420, the affine prediction function 430, and the cross-color prediction function 440. The selection device 450 also can output the color prediction parameters 114 utilized to generate the color space prediction 406. The color prediction control device 410 can control the timing of the generation of the color space prediction 406 and the type of operation performed to generate the color space prediction 406, for example, by controlling the timing and output of the selection device 450. In some embodiments, the color prediction control device 410 can control the timing of the generation of the color space prediction 406 and the type of operation performed to generate the color space prediction 406 by selectively providing the encoded BT.709 video stream 402 to at least one of the independent color channel prediction function 420, the affine prediction function 430, and the cross-color prediction function 440. It is to be understood that any color space prediction may be used, as desired.

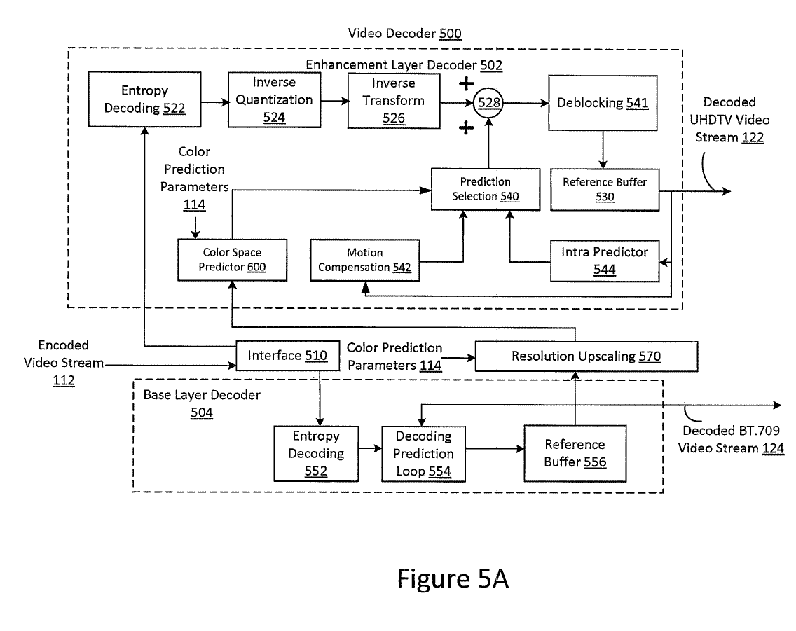

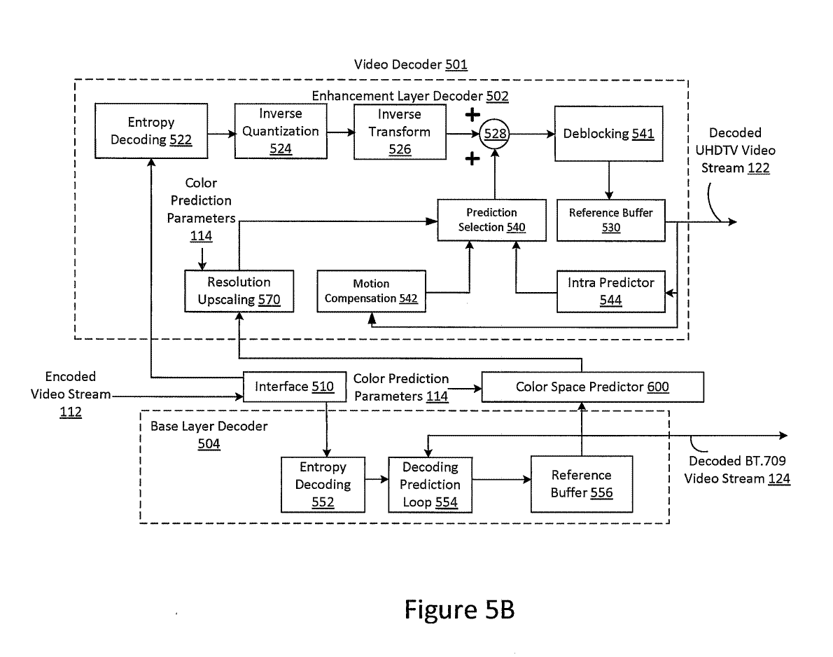

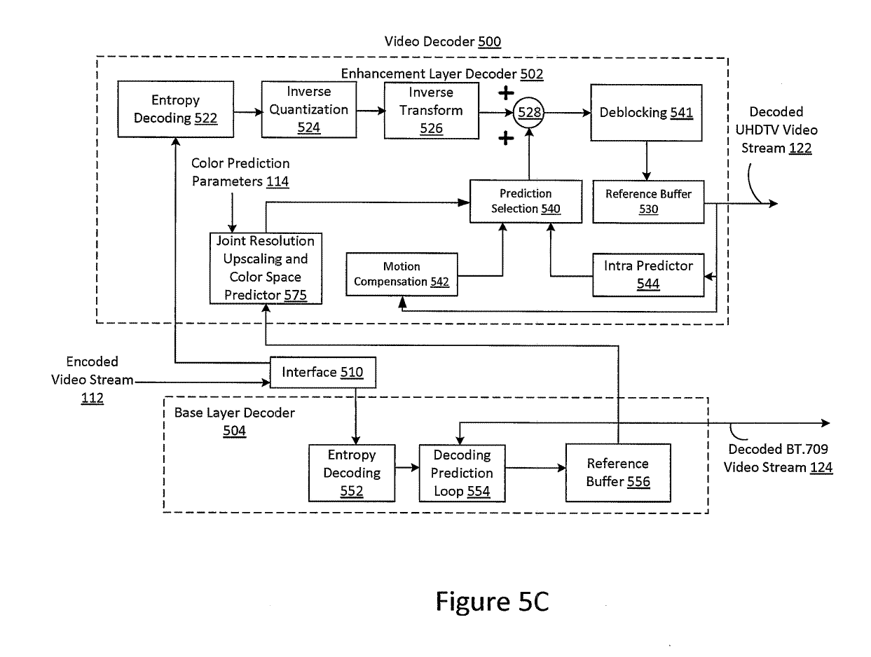

FIGS. 5A and 5B and 5C are block diagram examples of the video decoder 500 shown in FIG. 1. Referring to FIG. 5A, the video decoder can include an interface 510 to receive the encoded video stream 112, for example, from a video encoder 300. The interface 510 can demultiplex the encoded video stream 112 and provide encoded UHDTV image data to an enhancement layer decoder 502 of the video decoder 500 and provide encoded BT.709 image data to a base layer decoder 504 of the video decoder 500. The base layer decoder 504 can include an entropy decoding function 552 and a decoding prediction loop 554 to decode encoded BT.709 image data received from the interface 510, and store the decoded BT.709 video stream 124 in a reference buffer 556. The reference buffer 556 can provide the decoded BT.709 video stream 124 back to the decoding prediction loop 554 for use in decoding other portions of the same frame or other frames of the encoded BT.709 image data. The base layer decoder 504 can output the decoded BT.709 video stream 124. In some embodiments, the output from the decoding prediction loop 554 and input to the reference buffer 556 may be residual frame data rather than the reconstructed frame data.

The enhancement layer decoder 502 can include an entropy decoding function 522, a inverse quantization function 524, an inverse transform function 526, and a combination function 528 to decode the encoded UHDTV image data received from the interface 510. A deblocking function 541 can filter the decoded UHDTV image frame, for example, to smooth sharp edges in the image between regions corresponding to the decoded UHDTV image frame, and store the decoded UHDTV video stream 122 in a reference buffer 530. In some embodiments, the encoded UHDTV image data can correspond to a prediction residue, for example, a difference between a prediction and a UHDTV image frame as determined by the video encoder 300. The enhancement layer decoder 502 can generate a prediction of the UHDTV image frame, and the combination function 528 can add the prediction of the of the UHDTV image frame to encoded UHDTV image data having undergone entropy decoding, inverse quantization, and an inverse transform to generate the decoded UHDTV video stream 122. In some embodiments, the combination function 528 can include weighting, such as linear weighting, to generate the decoded UHDTV video stream 122.

The enhancement layer decoder 502 can include a color space predictor 600, a motion compensation prediction function 542, and an intra predictor 544, each of which can generate the prediction of the UHDTV image frame. The enhancement layer decoder 502 can include a prediction selection function 540 to select a prediction generated by the color space predictor 600, the motion compensation prediction function 542, and/or the intra predictor 544 to provide to the combination function 528.

In some embodiments, the motion compensation prediction function 542 and the intra predictor 544 can generate their respective predictions based on UHDTV image frames having previously been decoded by the enhancement layer decoder 502 and stored in the reference buffer 530. The motion compensation prediction function 542 can receive one or more decoded UHDTV image frames from the reference buffer 530. The motion compensation prediction function 542 can generate a prediction of a current UHDTV image frame based on image motion between the one or more decoded UHDTV image frames from the reference buffer 530 and the UHDTV image frame.

The intra predictor 544 can receive a first portion of a current UHDTV image frame from the reference buffer 530. The intra predictor 544 can generate a prediction corresponding to a first portion of a current UHDTV image frame based on at least a second portion of the current UHDTV image frame having previously been decoded by the enhancement layer decoder 502.

The color space predictor 600 can generate a prediction of the UHDTV image frames based on BT.709 image frames decoded by the base layer decoder 504. In some embodiments, the reference buffer 556 in the base layer decoder 504 can provide a portion of the decoded BT.709 video stream 124 to a resolution upscaling function 570, which can scale the resolution of the encoded BT.709 image frame to a resolution that corresponds to the UHDTV video format. The resolution upscaling function 570 can provide an upscaled resolution version of the encoded BT.709 image frame to the color space predictor 600. The color space predictor can generate a prediction of the UHDTV image frame based on the upscaled resolution version of the encoded BT.709 image frame. In some embodiments, the color space predictor 600 can scale a YUV color space of the upscaled resolution version of the encoded BT.709 image frame to correspond to the YUV representation supported by the UHDTV video format.

In some embodiments, the upscaling and color prediction are done jointly. The reference buffer 556 in the base layer decoder 504 can provide reconstructed BT.709 images frames to the joint upscaler color predictor 575. The joint upscaler color predictor generates an upscaled and color prediction of the UHDTV image frame. The combined upscaler and color prediction functions enable reduced complexity as well as avoiding loss of precision resulting from limited bit-depth between the separate upscaler and the color prediction modules. An example of the combination of upscaling and color prediction may be defined by a sample set of equations. Conventional upsampling implemented by separable filter calculations followed by an independent color prediction. Example calculations are shown below in three steps by equations 10, 11 and 12.

The input samples x_{i,j} are filtered in one direction by taps aₖ to give intermediates y_{i,j}. An offset, o₁, is added and the result is right shifted by the value s₁ as in Equation 10:

$${y}_{i , j} = ( {\sum }_{k} {a}_{k} \cdot {x}_{i - k , j} + {o}_{1} ) ≫ {s}_{1}$$

The intermediate samples y_{i,j} are then filtered by taps bₖ to give samples z_{i,j} and a second offset, o₂, is added and the result is right shifted by a second value, s₂ as in Equation 11:

$${z}_{i , j} = ( {\sum }_{k} {b}_{k} \cdot {y}_{i , j - k} + {o}_{2} ) ≫ {s}_{2}$$

The results of the upsampling process z_{i,j} are then processed by the color predition to generate prediction samples p_{i,j}. A gain is applied then an offset, o₃, is added before a final shift by s₃. The color prediction process described in Equation 12:

p_{i,j}=(gain·z_{i,j}+o₃)>>s₃

The complexity may be reduced by combining the color prediction calculation with the second separable filter calculation. The filter taps bₖ of Equation 11 are combined with the gain of Equation 12 to produce new taps cₖ=gain·bₖ the shift values of Equations 11 and Equation 12 are combined to give a new shift value s₄=s₂+s₃. The offset of Equation 12 is modified to o₄=o₃<<s₂. The individual calculations of Equation 11 and Equation 12 are defined in a single result Equation 13:

$${p}_{i , j} = ( ( {\sum }_{k} {c}_{k} \cdot {y}_{i , j - k} ) + {o}_{4} ) ≫ {s}_{4}$$

The combined calculation of Equation 13 has the advantage compared to Equations 11 and Equation 12 of reducing computation by using a single shift rather than two separate shifts and reducing the number of multiplies by premultiplying the filter taps by the gain value.

In some embodiments, it may be desirable to implement the separable filter calculations with equal taps so that aₖ=bₖ in Equation 10 and Equation 11. Direct application of the combined upscaling and color prediction removes this equality of taps since the values bₖ are replaced with the combined values cₖ An alternate embodiment will maintain this equality of taps. The gain is represented as a square of a value r shifted by a factor e in the form gain=(r·r)<<e. Where the value r is represented with m bits.

The results of Equations 10 and Equation 13 may be replaced by the pair of Equation 14 and Equation 15:

$${y}_{i , j} = ( {\sum }_{k} r \cdot {a}_{k} \cdot {x}_{i - k , j} + {o}_{5} ) ≫ {s}_{5}$$

$${p}_{i , j} = ( ( {\sum }_{k} r \cdot {a}_{k} \cdot {y}_{i , j - k} ) + {o}_{6} ) ≫ {s}_{6}$$

The offsets and shifts used in Equation 15 and Equation 16 are derived from the values in Equations 10 and Equation 13 and the representation of the gain value as shown in Equation 16:

o₅=o₁<<m

s₅=s₁+m

o₆=o₄<<(m+e)

s₆=s₄+m+e

The filter calculations in Equation 15 and Equation 16 use equal tap values r·aₖ. The use of the exponent factor e allows large gain values to be approximated with small values of r by increasing the value of e.

The color space predictor 600 can operate similarly to the color space predictor 400 in the video encoder 300, by scaling the color space supported by BT.709 video coding standard to a color space supported by the UHDTV video format, for example, with independent channel prediction, affine mixed channel prediction, or cross-color channel prediction. The color space predictor 600, however, can select a type of color space prediction to generate based, at least in part, on the color prediction parameters 114 received from the video encoder 300. The color prediction parameters 114 can explicitly identify a particular a type of color space prediction, or can implicitly identify the type of color space prediction, for example, by a quantity and/or arrangement of the color prediction parameters 114.

As discussed above, in some embodiments, the normative portion of the encoded video stream 112 can include a flag (use_color_space_prediction), for example, one or more bits, which can annunciate an inclusion of color space parameters 114 in the encoded video stream 112. The normative portion of the encoded video stream 112 can include a size parameter (color_predictor_num_fraction_bits_minus1), for example, one or more bits, which can identify a number of bits or precision utilized to represent each parameter. The normative portion of the encoded video stream 112 can include a predictor type parameter (color_predictor_idc), for example, one or more bits, which can identify a type of color space prediction utilized by the video encoder 300 to generate the color space prediction. The types of color space prediction can include independent channel prediction, affine prediction, their various implementations, or the like. The color prediction parameters 114 can include gain parameters, offset parameters, and/or matrix parameters depending on the type of prediction utilized by the video encoder 300.

The color space predictor 600 identify whether the video encoder 300 utilize color space prediction in generating the encoded video stream 112 based on the flag (use_color_space_prediction). When color prediction parameters 114 are present in the encoded video stream 112, the color space predictor 600 can parse the color prediction parameters 114 to identify a type of color space prediction utilized by the video encoded based on the predictor type parameter (color_predictor_idc), and a size or precision of the parameters (color_predictor_num_fraction_bits_minus1), and locate the color space parameters to utilize, to generate a color space prediction.

For example, the video decoder 500 can determine whether the color prediction parameters 114 are present in the encoded video stream 112 and parse the color prediction parameters 114 based on the following example code in Table 2:

TABLE 2

```
use_color_space_prediction
if(use_color_space_prediction) {
  color_predictor_num_fraction_bits_minus1
  color_prediction_idc
  if(color_prediction_idc==0) {
    for( i = 0; i < 3; i++ ){
      color_predictor_gain [ i ]
    }
  }
  if(color_prediction_idc==1) {
    for( i = 0; i < 3; i++ ){
      color_predictor_gain [ i ]
      color_predictor_offset [ i ]
    }
  }
  if(color_prediction_idc==2) {
    for( i = 0; i < 3; i++ ){
      for( j= 0; j < 3; j++ ){
        cross_color_predictor_gain [ i ][j]
      }
      color_predictor_offset [ i ]
    }
  }
```

It is to be understood that any technique may be used to encode and/or decode the color prediction parameters.

The example code in Table 2 can allow the video decoder 500 to identify whether color prediction parameters 114 are present in the encoded video stream 112 based on the use_color_space_prediction flag. The video decoder 500 can identify the precision or size of the color space parameters based on the size parameter (color_predictor_num_fraction_bits_minus1), and can identify a type of color space prediction utilized by the video encoder 300 based on the type parameter (color_predictor_idc). The example code in Table 2 can allow the video decoder 500 to parse the color space parameters from the encoded video stream 112 based on the identified size of the color space parameters and the identified type color space prediction utilized by the video encoder 300, which can identify the number, semantics, and location of the color space parameters. Although the example code in Table 2 shows the affine prediction including 9 matrix parameters and 3 offset parameters, in some embodiments, the color prediction parameters 114 can include fewer matrix and/or offset parameters, for example, when a subset of the matrix parameters are zero, and the example code can be modified to parse the color prediction parameters 114 accordingly.

An alternate method for signaling the color prediction parameters is described here. The structure of the Picture Parameter Set (PPS) of HEVC is shown in the table 3 below:

TABLE 3

| pic_parameter_set_rbsp( ) { | Descriptor |
|---|---|
| pic_parameter_set_id | ue(v) |
| seq_parameter_set_id | ue(v) |
| sign_data_hiding_flag | u(1) |
| cabac_init_present_flag | u(1) |
| num_ref_idx_l0_default_active_minus1 | ue(v) |
| num_ref_idx_l1_default_active_minus1 | ue(v) |
| pic_init_qp_minus26 | se(v) |
| constrained_intra_pred_flag | u(1) |
| transform_skip_enabled_flag | u(1) |
| cu_qp_delta_enabled_flag | u(1) |
| if ( cu_qp_delta_enabled_flag ) | |
| diff_cu_qp_delta_depth | ue(v) |
| pic_cb_qp_offset | se(v) |
| pic_cr_qp_offset | se(v) |
| pic_slice_level_chroma_qp_offsets_present_flag | u(1) |
| weighted_pred_flag | u(1) |
| weighted_bipred_flag | u(1) |
| output_flag_present_flag | u(1) |
| transquant_bypass_enable_flag | u(1) |
| dependent_slice_enabled_flag | u(1) |
| tiles_enabled_flag | u(1) |
| entropy_coding_sync_enabled_flag | u(1) |
| entropy_slice_enabled_flag | u(1) |
| if( tiles_enabled_flag ) { | |
| num_tile_columns_minus1 | ue(v) |
| num_tile_rows_minus1 | ue(v) |
| uniform_spacing_flag | u(1) |
| if( !uniform_spacing_flag) { | |
| for( i = 0; i < num_tile_columns_minus1; i++ ) | |
| column_width_minus1[ i ] | ue(v) |
| for( i = 0; i < num_tile_rows_minus1; i++ ) | |
| row_height_minus1[ i ] | ue(v) |
| } | |
| loop_filter_across_tiles_enabled_flag | u(1) |
| } | |
| loop_filter_across_slices_enabled_flag | u(1) |
| deblocking_filter_control_present_flag | u(1) |
| if( deblocking_filter_control_present_flag ) { | |
| deblocking_filter_override_enabled_flag | u(1) |
| pps_disable_deblocking_filter_flag | u(1) |
| if( !pps_disable_deblocking_filter_flag ) { | |
| beta_offset_div2 | se(v) |
| tc_offset_div2 | se(v) |
| } | |
| } | |
| pps_scaling_list_data_present_flag | u(1) |
| if( pps_scaling_list_data_present_flag ) | |
| scaling_list_data( ) | |
| log2_parallel_merge_level_minus2 | ue(v) |
| slice_header_extension_present_flag | u(1) |
| slice_extension_present_flag | u(1) |
| pps_extension_flag | u(1) |
| if( pps_extension_flag ) | |
| while( more_rbsp_data( ) ) | |
| pps_extension_data_flag | u(1) |
| rbsp_trailing_bits( ) | |
| } | |

Additional fields to carry color prediction data are added when the pps_extension_flag is set equal to 1.

pps_extension_flag equal to 0 specifies that no pps_extension_data_flag syntax elements are present in the PPS RBSP syntax structure.

In extension data signal the following:

A flag to use color prediction on the current picture

Indicator of color prediction model used to signal gain and offset values.

TABLE 4

| Color_prediction_model | index |
|---|---|
| Bit Increment | 0 |
| Fixed Gain Offset | 1 |
| Picture Adaptive Gain Offset | 2 |

For each model the following values are signaled or derived: number_gain_fraction_bits, gain[ ] and offset[ ] values for each color component.

Bit Increment (BI) model: the number of fraction bits is zero, the gain values are equal and based on the difference in bit-depth between base and enhancement layer i.e. 1<<(bit_depth_EL-bit-depth_BL), all offset values are zero.

Fixed Gain Offset model: an index is signaled indicating the use of a set of parameters signaled previously for instance out of band or through a predefined table of parameter values. This index indicates a previously define set of values including: number of fraction bits, gain and offset values for all components. These values are not signaled but reference to a predefined set. If only a single set of parameters is predefined, an index is not sent and this set is used when the Fixed Gain Offset model is used.

Picture Adaptive Gain Offset Offset model: parameter values are signaled in the bitstream through the following fields. Number of fraction bits is signaled as an integer in a predefined range i.e. 0-5. For each channel gain and offset values are signaled as integers. An optional method is to signal the difference between the Fixed Gain Offset model and the parameter values of the Picture Adaptive Gain Offset model.

Each layer will may have independently specified color space for instance using the hEVC Video Usability Information (VUI) with colour_description_present_flag indicating the presence of colour information. As an example, separate VUI fields can be specified for each layer through different Sequence Parameter Sets.

colour_description_present_flag equal to 1 specifies that colour primaries, transfer characteristics and matrix coefficients are present. colour description_present_flag equal to 0 specifies that colour primaries, transfer characteristics and matrix coefficients are not present.

The color space predictor 600 can generate color space predictions for the prediction selection function 540 on a per sequence (inter-frame), a per frame, or a per slice (intra-frame) basis. In some embodiments, the color space predictor 600 can generate the color space predictions with a fixed or preset timing or dynamically in response to a reception of the color prediction parameters 114 from the video encoder 300.

Referring to FIG. 5B, a video decoder 501 can be similar to video decoder 500 shown and described above in FIG. 5A with the following differences. The video decoder 501 can switch the color space predictor 600 with the resolution upscaling function 570. The color space predictor 600 can generate a prediction of the UHDTV image frames based on portions of the decoded BT.709 video stream 124 from the base layer decoder 504.

In some embodiments, the reference buffer 556 in the base layer decoder 504 can provide the portions of the decoded BT.709 video stream 124 to the color space predictor 600. The color space predictor 600 can scale a YUV color space of the portions of the decoded BT.709 video stream 124 to correspond to the YUV representation supported by the UHDTV video standard. The color space predictor 600 can provide the color space prediction to a resolution upscaling function 570, which can scale the resolution of the color space prediction to a resolution that corresponds to the UHDTV video standard. The resolution upscaling function 570 can provide a resolution upscaled color space prediction to the prediction selection function 540.

FIG. 6 is a block diagram example of a color space predictor 600 shown in FIG. 5A. Referring to FIG. 6, the color space predictor 600 can include a color space prediction control device 610 to receive the decoded BT.709 video stream 122, for example, from a base layer decoder 504 via a resolution upscaling function 570, and select a prediction type and timing for a generation for a color space prediction 606. The color space predictor 600 can select a type of color space prediction to generate based, at least in part, on the color prediction parameters 114 received from the video encoder 300. The color prediction parameters 114 can explicitly identify a particular a type of color space prediction, or can implicitly identify the type of color space prediction, for example, by a quantity and/or arrangement of the color prediction parameters 114. In some embodiments, the color space prediction control device 610 can pass the decoded BT.709 video stream 122 and color prediction parameters 114 to at least one of an independent channel prediction function 620, an affine prediction function 630, or a cross-color prediction function 640. Each of the prediction functions 620, 630, and 640 can generate a color space prediction of a UHDTV image frame (or portion thereof) from the decoded BT.709 video stream 122, for example, by scaling the color space of a BT.709 image frame to a color space of the UHDTV image frame based on the color space parameters 114. It is to be understood that any suitable color space and/or representation may be used, as desired.

The independent color channel prediction function 620 can scale YUV components of the decoded BT.709 video stream 122 separately, for example, as shown above in Equations 1-6. The affine prediction function 630 can scale YUV components of the decoded BT.709 video stream 122 with a matrix multiplication, for example, as shown above in Equation 7. The cross-color prediction function 640 can scale YUV components of the decoded BT.709 video stream 122 with a modified matrix multiplication that can eliminate mixing of a Y component from the decoded BT.709 video stream 122 when generating the U and V components of the UHDTV image frame, for example, as shown above in Equations 8 or 9.

In some embodiments, the color space predictor 600 can include a selection device 650 to select an output from the independent color channel prediction function 620, the affine prediction function 630, and the cross-color prediction function 640. The color prediction control device 610 can control the timing of the generation of the color space prediction 606 and the type of operation performed to generate the color space prediction 606, for example, by controlling the timing and output of the selection device 650. In some embodiments, the color prediction control device 610 can control the timing of the generation of the color space prediction 606 and the type of operation performed to generate the color space prediction 606 by selectively providing the decoded BT.709 video stream 122 to at least one of the independent color channel prediction function 620, the affine prediction function 630, and the cross-color prediction function 640.

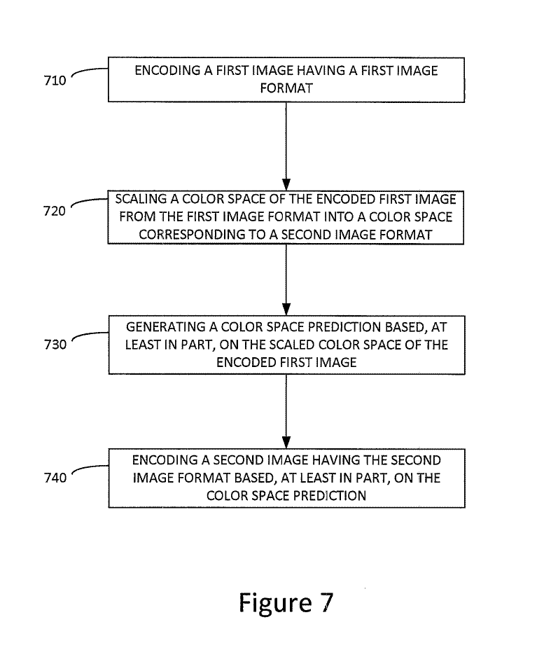

FIG. 7 is an example operational flowchart for color space prediction in the video encoder 300. Referring to FIG. 7, at a first block 710, the video encoder 300 can encode a first image having a first image format. In some embodiments, the first image format can correspond to a BT.709 video standard and the video encoder 300 can include a base layer to encode BT.709 image frames.

At a block 720, the video encoder 300 can scale a color space of the first image from the first image format into a color space corresponding to a second image format. In some embodiments, the video encoder 300 can scale the color space between the BT.709 video standard and an Ultra High Definition Television (UHDTV) video standard corresponding to the second image format.

There are several ways for the video encoder 300 to scale the color space supported by BT.709 video coding standard to a color space supported by the UHDTV video format, such as independent channel prediction and affine mixed channel prediction. For example, the independent color channel prediction can scale YUV components of encoded BT.709 image frames separately, for example, as shown above in Equations 1-6. The affine mixed channel prediction can scale YUV components of the encoded BT.709 image frames with a matrix multiplication, for example, as shown above in Equations 7-9.

In some embodiments, the video encoder 300 can scale a resolution of the first image from the first image format into a resolution corresponding to the second image format. For example, the UHDTV video standard can support a 4 k (3840×2160 pixels) or an 8 k (7680×4320 pixels) resolution and a 10 or 12 bit quantization bit-depth. The BT.709 video standard can support a 2 k (1920×1080 pixels) resolution and an 8 or 10 bit quantization bit-depth. The video encoder 300 can scale the encoded first image from a resolution corresponding to the BT.709 video standard into a resolution corresponding to the UHDTV video standard.

At a block 730, the video encoder 300 can generate a color space prediction based, at least in part, on the scaled color space of the first image. The color space prediction can be a prediction of a UHDTV image frame (or portion thereof) from a color space of a corresponding encoded BT.709 image frame. In some embodiments, the video encoder 300 can generate the color space prediction based, at least in part, on the scaled resolution of the first image.

At a block 740, the video encoder 300 can encode a second image having the second image format based, at least in part, on the color space prediction. The video encoder 300 can output the encoded second image and color prediction parameters utilized to scale the color space of the first image to a video decoder.

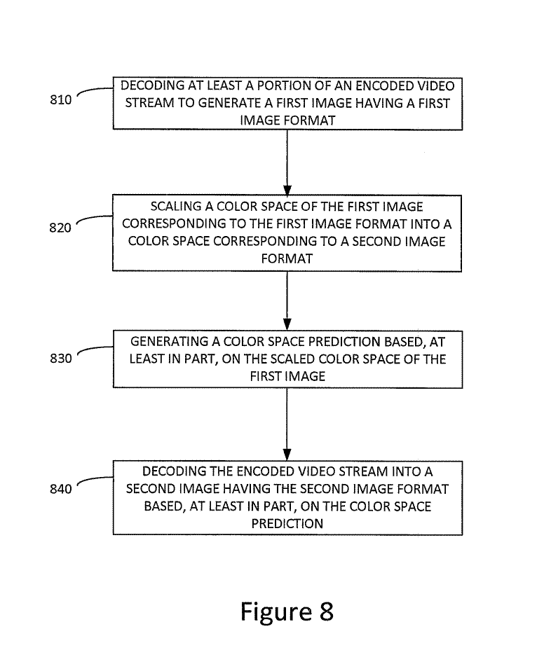

FIG. 8 is an example operational flowchart for color space prediction in the video decoder 500. Referring to FIG. 8, at a first block 810, the video decoder 500 can decode an encoded video stream to generate a first image having a first image format. In some embodiments, the first image format can correspond to a BT.709 video standard and the video decoder 500 can include a base layer to decode BT.709 image frames.

At a block 820, the video decoder 500 can scale a color space of the first image corresponding to the first image format into a color space corresponding to a second image format. In some embodiments, the video decoder 500 can scale the color space between the BT.709 video standard and an Ultra High Definition Television (UHDTV) video standard corresponding to the second image format.

There are several ways for the video decoder 500 to scale the color space supported by BT.709 video coding standard to a color space supported by the UHDTV video standard, such as independent channel prediction and affine mixed channel prediction. For example, the independent color channel prediction can scale YUV components of the encoded BT.709 image frames separately, for example, as shown above in Equations 1-6. The affine mixed channel prediction can scale YUV components of the encoded BT.709 image frames with a matrix multiplication, for example, as shown above in Equations 7-9.

The video decoder 500 can select a type of color space scaling to perform, such as independent channel prediction or one of the varieties of affine mixed channel prediction based on channel prediction parameters the video decoder 500 receives from the video encoder 300. In some embodiments, the video decoder 500 can perform a default or preset color space scaling of the decoded BT.709 image frames.

The video decoder 500 may pre-determine the type of color-prediction to perform. The exact parameters to be used for the chosen color-prediction may be determined based on the corresponding pixel value(s) in the BT.709 image frame. In an example embodiment the BT.709 color space may be partitioned into regions and each region may correspond to the parameter values to be used for the chosen color-prediction. The corresponding pixel value(s) in BT.709 image frame corresponds to a region which in turn corresponds to parameters to be used for the chosen color-prediction. The parameter values corresponding to each partition of the BT.709 region may be signaled in the bitstream, for example, in the slice header or its extension, in the picture parameter set or its extension, in the sequence parameter set or its extension, in the video parameter set or its extension. In some embodiments all or a subset of parameters corresponding to a partition of the BT.709 region may be inferred (or derived based on past data) and not explicitly signaled.

The coding tree block is an N×N block of samples for some value of N such that the division of a component into coding tree blocks is a partitioning.

The coding tree unit is a coding tree block of luma samples, two corresponding coding tree blocks of chroma samples of a picture that has three sample arrays, or a coding tree block of samples of a monochrome picture or a picture that is coded using three separate colour planes and syntax structures used to code the samples.

The slice segment header is a part of a coded slice segment containing the data elements pertaining to the first or all coding tree units represented in the slice segment.

The slice header is the slice segment header of the independent slice segment that is a current slice segment or the most recent independent slice segment that precedes a current dependent slice segment in decoding order.

The sequence parameter set (SPS) is a syntax structure containing syntax elements that apply to zero or more entire Coded Video Sequences (CVSs) as determined by the content of a syntax element found in the PPS referred to by a syntax element found in each slice segment header.

The picture parameter set (PPS) is a syntax structure containing syntax elements that apply to zero or more entire coded pictures as determined by a syntax element found in each slice segment header.

The video parameter set (VPS) is a syntax structure containing syntax elements that apply to zero or more entire CVSs as determined by the content of a syntax element found in the SPS referred to by a syntax element found in the PPS referred to by a syntax element found in each slice segment header.

Listed below in Table 5 is an exemplary region-wise parameter signaling (to be used for color-prediction) in the slice header. The color-prediction type used in this example corresponds to equation 7 (Note, the described technique applies to any alternative type of color-prediction as well). When the syntax element infer_parameters[r] takes on the value one; the parameters for region with index r are set to pre-determined values. When the syntax element infer_parameters[r] takes on the value zero; the parameters for region with index r are explicitly signaled in the bitstream. The syntax elements cross_color_predictor_gain[r][i][j] and color_predictor_offset[r][i] represent values corresponding to mᵢⱼ and oᵢ respectively of equation 7. The parameter mᵢⱼ (and cross_color_predictor_gain[r][i][j]) may also be referred to as the cross-color gain parameter and the parameter oᵢ (and color_predictor_offset[r][i]) may also be referred to as the offset parameter.

TABLE 5

| slice_segment_header( ) { | Descriptor |
|---|---|
| ... | ... |
| for (r=0; r<number_of_region; r++) | |
| infer_parameters[r] | u(1) |
| if (!infer_parameters[r]) { | |
| for( i = 0; i < 3; i++ ) { | |
| for( j = 0; j < 3; j++ ) { | |
| cross_color_predictor_gain[r][i][j] | se(v) |
| } | |
| color_predictor_offset[r][i] | se(v) |
| } | |
| } | |
| ... | |
| } | |

A technique that results in a reduction of bits used to signal the color-prediction parameters corresponding to a color space region r in the bitstream is as follows: Signaling each of the color-prediction parameter (cross-color gain or offset) values may include as a first step selecting amongst a set of predicted values which value(s) to use as reference. As a second step the color-prediction parameter (cross-color gain or offset) value may be signaled as a differential with respect to the chosen reference value(s). For example, during decoding, the color-prediction parameter values may be determined in a sequential manner, based upon a prediction, using one or more of the color-prediction parameter values, such as 5 (first cross-color gain value or first color-prediction parameter), 7 (second cross-color gain value or second color-prediction parameter), 10 (third cross-color gain value or third color-prediction parameter), 12 (first offset value or fourth color-prediction parameter), 20 (fourth cross-color gain value or fifth color-prediction parameter), 50 (fifth cross-color gain value or sixth color-prediction parameter), 90 (sixth cross-color gain value or seventh color-prediction parameter), 22 (second offset value or eighth color-prediction parameter), 64 (seventh cross-color gain value or ninth color-prediction parameter), 55 (eighth cross-color gain value or tenth color-prediction parameter), 44 (ninth cross-color gain value or eleventh color-prediction parameter), 33 (third offset value or twelfth color-prediction parameter). Thus, the sixth color-prediction parameter (fifth cross-color gain value) may be predicted based upon one or more previous color-prediction parameters, such as the fifth color-prediction parameter (fourth cross-color gain) value indicated by cross_color_predictor_gain[r][1][0]. The diff_cross_color_predictor_gain[r][1][1] corresponding to the fifth color-prediction parameter (fourth cross-color gain) would then be used in combination with the cross_color_predictor_gain[r][1][0] to predict the cross color_predictor_gain[r][1][1]. In some cases to reduce memory requirements or the number of bits to signal pred_parameter_index[i], the list of available color-prediction parameter values may be truncated to a list of less than a predetermined set of values, such as 4. In some cases, the color-prediction parameter cross_color_predictor_gain[r][0][0] does not need the corresponding pred_parameter_index[i] since there is no list nor does it need the diff_cross_color_predictor_gain[r][0][0] since the first value is not a differential other than to zero; as a result the differential would correspond to the original parameter value to be signaled. In some cases to reduce memory requirements or the number of bits to signal pred_parameter_index[i], the second color-prediction parameter does not need the pred_parameter_index[i] since there is only one index in the list. An exemplary manner of signaling color-prediction parameters in the bitstream consistent with the example may be as shown in Table 6:

TABLE 6

| slice_segment_header( ) { | Descriptor |
|---|---|
| ... | ... |
| for (r=0; r<number_of_region; r++) | |
| infer_parameters[r] | u(1) |
| if (!infer_parameters[r]) { | |
| for( i = 0, p_idx=0; i < 3; i++ ) { | |
| for( j = 0; j < 3; j++ ) { | |
| if( i == 0 && j == 0) { | |
| diff_cross_color_predictor_gain[r][i][j] | se(v) |
| } else { | |
| pred_parameter_index[p_idx++] | ue(v) |
| diff_cross_color_predictor_gain[r][i][j] | se(v) |
| } | |
| } | |
| pred_parameter_index[p_idx++] | ue(v) |
| diff_color_predictor_offset[r][i] | se(v) |
| } | |
| } | |
| ... | |
| } | |

For the exemplary signaling in Table 6 the color-prediction parameter values for color space region with index r may be determined as follows:

```
for (i=0, p_idx = 0; i<3; i++) {
  for (j=0; j<3; j++) {
  if( i==0 && j==0 ) {
    cross_color_predictor_gain[r][0][0]=
    diff_cross_color_ predictor_gain[r][0][0]
  } else {
    cross_color_predictor_gain[r][i][j]=
                  diff_cross_color_predictor_gain[r][i][j] +
                  pred_parameter_set[pred_parameter_index[p_idx−
1]
  }
  pred_parameter_set[p_idx++] = cross_color_predictor_gain[r][i][j]
  } // end for j
  color_predictor_offset[r][i]=diff_color_predictor_offset[r][i] +
                  pred_parameter_set[pred_parameter_index[p_idx−
1]]
  pred_parameter_set[p_idx++] = color_predictor_offset[r][i]
} // end for i
```

The total number of color space regions is equal to number of region.

Another technique that results in a reduction of bits used to signal the color-prediction parameters corresponding to a color space region r in the bitstream is as follows: A first step may include sending a predictor for color-prediction parameter value, such as min_color_prediction_parameter. The predictor for color-prediction parameter value may be decreased by 1. The predictor for color-prediction parameter value may be based in some manner to a series of color-prediction parameter values, such as for example, a minimum color-prediction parameter value, a maximum color-prediction parameter value, an average color-prediction parameter value, a mean color-prediction parameter value, etc. For example, with a set of color-prediction parameter values being {50, 70, 100, 150 57, 70, 60, 55}, the minimum color-prediction parameter value may be 50 or minimum color-prediction parameter value minus 1 may be 49. The predictor e.g. minimum color-prediction parameter value may be provided, namely, min_color_prediction_parameter. The second step may include coding the color-prediction parameter using any suitable technique. For example, the differential of color-prediction parameter values with respect to predictor value of 50 may be coded as {0, 20, 50, 100, 7, 20, 10, 5}. The second step may include sending all color-prediction parameter values based on a predictor-based encoding technique, namely diff_cross_color_predictor_gain[r][i][j] and diff_color_predictor_offset[r][i], combined with a k-th order Exponential Golomb code. The value of “k” may be selected in any suitable manner. It is noted that for a larger parameter value, a larger “k” gives a correspondingly shorter codeword. It is also noted that for a smaller parameter value, a larger “k” gives a correspondingly longer codeword. Accordingly, the value of “k” may be modified in a manner suitable to reduce the number of bits required for signaling the color prediction parameter values, while still maintaining a computationally efficient technique. For example “k” may be modified based on all or a subset of: previously signaled color prediction parameter values, quantization parameter, slice type, spatial characteristics of the video content being coded, “k” values chosen by spatial neighbors. One exemplary manner of signaling the color-prediction parameters in the bitstream consistent with the example may be as shown in Table 7:

TABLE 7

| slice_segment_header( ) { | Descriptor |
|---|---|
| ... | ... |
| for (r=0; r<number_of_region; r++) | |
| infer_parameters[r] | u(1) |
| if (!infer_parameters[r]) { | |
| min_color_prediction_parameter | se(v) |
| for( i = 0, p_idx=0; i < 3; i++ ) { | |
| for( j = 0; j < 3; j++ ) { | |
| diff_cross_color_predictor_gain[r][i][j] | ue(v) |
| } | |
| diff_color_predictor_offset[r][i] | ue(v) |
| } | |
| } | |
| ... | |
| } | |

For the exemplary signaling in Table 7 the color-prediction parameter values for color space region r may be determined as follows:

```
for (i=0; i<3; i++) {
  for (j=0; j<3; j++) {
  cross_color_predictor_gain[r][i][j]=
                          diff_cross_color_predictor_gain[r][i][j] +
                          min_color_prediction_parameter
  } // end for j
  color_predictor_offset[r][i]=diff_color_predictor_offset[r][i] +
                          min_color_prediction_parameter
} // end for i
```

The total number of color space regions is equal to number of region.

Another technique that results in a reduction of bits used to signal the color-prediction parameters corresponding to a color space region r in the bitstream is as follows: A first optional step may include sending a predictor for color-prediction parameter value, such as min_color_prediction_parameter. The predictor for color-prediction parameter value may be decreased by 1. The predictor for color-prediction parameter value may be based in some manner to a series of color-prediction parameter values, such as for example, a minimum color-prediction parameter value, a maximum color-prediction parameter value, an average color-prediction parameter value, a mean color-prediction parameter value, etc. For example, with a set of color-prediction parameter values being {50, 70, 100, 150, 57, 70, 60, 55}, the minimum color-prediction parameter value may be 50 or minimum color-prediction parameter value minus 1 may be 49. The predictor e.g. minimum color-prediction parameter value may be provided, namely, min_color_prediction_parameter. The second step may include coding the predicted color-prediction parameter values using any suitable technique for a quotient and a remainder. For example, in the expressions a/b=c and a % b=d, a is referred to as the dividend, b is referred to as the divisor, c is referred to as the quotient and d is referred to as the remainder. In this manner, each of the predicted color-prediction parameter values are divided by the given divisor, thus the resulting quotient and the remainder are preferably transmitted in the bitstream. The divisor may be determined based upon any suitable characteristic, such as for example, the slice type, quantization parameter, image content, the number of color-prediction parameter values, the resolution of image etc. In one embodiment, the divisor is selected by an encoder and transmitted to a decoder. The second step may include sending the quotient and the remainder for all predicted color-prediction parameter values based on any suitable technique, such as fixed length codewords and/or variable length codewords. The range of the remainder may be from ‘0’ to divisor−1. One exemplary manner of signaling the color-prediction parameter values in the bitstream consistent with the example is shown in Table 8:

TABLE 8

| slice_segment_header( ) { | Descriptor |
|---|---|
| ... | ... |
| for (r=0; r<number_of_region; r++) | |
| infer_parameters[r] | u(1) |
| if (!infer_parameters[r]) { | |
| for( i = 0; i < 3; i++ ) { | |
| for( j = 0; j < 3; j++ ) { | |
| cross_color_predictor_gain_q[r][i][j] | ue(v) |
| cross_color_predictor_gain_r[r][i][j] | u(7) |
| if ( cross_color_predictor_gain_q[r][i][j] \|\| | |
| cross_color_predictor_gain_r[r][i][j] ) | |
| cross_color_predictor_gain_s[r][i][j] | u(1) |
| } | |
| color_predictor_offset_q[r][i] | ue(v) |
| color_predictor_offset_r[r][i] | u(7) |
| if (color_predictor_offset_q[r][i] \|\| | |
| color_predictor_offset_r[r][i] ) | |
| color_predictor_offset_s[r][i] | u(1) |
| } | |
| } | |
| ... | |
| } | |

For the exemplary signaling in Table 8 the divisor is (1<<7); the quotients for the cross-color gain and offset parameters are cross_color_predictor_gain_q[r][i][j] and color_predictor_offset_q[r][i] respectively; the remainders for the cross-color gain and offset parameters are cross_color_predictor_gain_r[r][i][j] and color_predictor_offset_r[r][i] respectively; and the signs for the cross-color gain and offset parameters are indicated by cross_color_predictor_gain_s[r][i][j] and color_predictor_offset_s[r][i] respectively. When the syntax elements corresponding to the sign is not signaled their values are inferred to be 0. A value of 0 for the sign syntax element represents positive color-prediction parameter value and 1 represents negative color-prediction parameter value. The color-prediction parameter values for color space region r may then be determined as follows:
cross_color_predictor_gain[r][i][j]=(cross_color_predictor_gain_q[r][i][j]<<7)+cross_color_predictor_gain_r[r][i][j]
if (cross_color_predictor_gain[r][i][j] && cross_color_predictor_gain_s[r][i][j]) cross_color_predictor_gain[r][i][j]=−cross_color_predictor_gain[r][i][j]
color_predictor_offset[r][i]=(color_predictor_offset_q[r][i]<<7)+color_predictor_offset_r[r][i]
if (color_predictor_offset[r][i] && color_predictor_offset_s[r][i]) color_predictor_offset[r][i]=−color_predictor_offset[r][i]
   The above signalling and derivation may be modified appropriately for different value of a divisor. The total number of color space regions is equal to number of region.

Another technique that results in a reduction of bits used to signal the color-prediction parameters corresponding to a color space region r in the bitstream is as follows: An optional first step may include sending a predictor for color-prediction parameter value, such as min_color_prediction_parameter. The predictor for color-prediction parameter value may be decreased by 1. The predictor for color-prediction parameter value may be based in some manner to a series of color-prediction parameter values, such as for example, a minimum color-prediction parameter value, a maximum color-prediction parameter value, an average color-prediction parameter value, a mean color-prediction parameter value, a predicted color-prediction parameter value set, etc. For example, with a set of color-prediction parameter values being {50, 70, 100, 150, 57, 70, 60, 55}, the minimum color-prediction parameter value may be 50 or minimum color-prediction parameter value minus 1 may be 49. The predictor e.g. minimum color-prediction parameter value may be provided, namely, min_color_prediction_parameter. The second step may include sending a divisor for use in decoding predicted color-prediction parameter. The divisor may be sent in an encoded manner, such as the power of two minus 1 (i.e., divisor=2^{z} where ‘z−1’ is sent). As a general matter, the divisor may be encoded in any manner, such as for example, z−2, z+1. The signaling of the divisor may be in any desirable location, such as in the slice header or its extension, in the picture parameter set or its extension, the sequence parameter set or its extension, the video parameter set or its extension. The third step may include encoding the predicted color-prediction parameter using any suitable technique using the divisor together with a quotient and a remainder. In this manner, each of the color-prediction parameter is divided by the given divisor, thus defining the relationship between the quotient and the remainder. The quotients and remainders for the color-prediction parameter may be sent based on any suitable technique, such as fixed length codewords and/or variable length codewords. For example, the system may signal the divisor with a specific variable length codeword and the remainder with a fixed length codeword, where the length is determined by z. An increase in the coding efficiency may be achieved by more optimal selection of the divisor. The range of the remainder may be from ‘0’ to divisor−1. One exemplary manner of signaling color-prediction parameters in the bitstream consistent with the example is shown in Table 9:

TABLE 9

| slice_segment_header( ) { | Descriptor |
|---|---|
| ... | ... |
| for (r=0; r<number_of_region; r++) | |
| infer_parameters[r] | u(1) |
| if (!infer_parameters[r]) { | |
| divisor_power_of_two_minus1 | ue(v) |
| for( i = 0; i < 3; i++ ) { | |
| for( j = 0; j < 3; j++ ) { | |
| cross_color_predictor_gain_q[r][i][j] | ue(v) |
| cross_color_predictor_gain_r[r][i][j] | u(v) |
| if ( cross_color_predictor_gain_q[r][i][j] \|\| | |
| cross_color_predictor_gain_r[r][i][j] ) | |
| cross_color_predictor_gain_s[r][i][j] | u(1) |
| } | |
| color_predictor_offset_q[r][i] | ue(v) |
| color_predictor_offset_r[r][i] | u(v) |
| if (color_predictor_offset_q[r][i] \|\| | |
| color_predictor_offset_r[r][i] ) | |
| color_predictor_offset_s[r][i] | u(1) |
| } | |
| } | |
| ... | |
| } | |

For the exemplary signaling in Table 9 the divisor is:

Dv=(1<<(divisor_power_of_two_minus1+1));
the quotients for the cross-color gain and offset parameters are
cross_color_predictor_gain_q[r][i][j] and color_predictor_offset_q[r][i] respectively;
the remainders for the cross-color gain and offset parameters are
cross_color_predictor_gain_r[r][i][j] and color_predictor_offset_r[r][i] respectively;
and the signs for the cross-color gain and offset parameters are indicated by
cross_color_predictor_gain_s[r][i][j] and color_predictor_offset_s[r][i] respectively.
When the syntax elements corresponding to the sign is not signaled their values are inferred to be 0. A value of 0 for the sign syntax element represents positive color-prediction parameter value and 1 represents negative color-prediction parameter value. The color-prediction parameter values for color space region r may then be determined as follows:
cross_color_predictor_gain[r][i][j]=(cross_color_predictor_gain_q[r][i][j]*Dv)+cross_color_predictor_gain_r[r][i][j]
if (cross_color_predictor_gain[r][i][j] && cross_color_predictor_gain_s[r][i][j]) cross_color_predictor_gain[r][i] [j]=−cross_color_predictor_gain [r] [i] [j]
color_predictor_offset[r][i]=(color_predictor_offset_q[r][i]Dv)+color_predictor_offset_r[r] [i]
if (color_predictor_offset[r][i] && color_predictor_offset_s[r][i]) color_predictor_offset[r][i]=−color_predictor_offset[r][i]
   The above signalling and derivation may be modified appropriately for different value of a divisor. The total number of color space regions is equal to number of region.

The cross_color_predictor_gain_q parameter, cross_color_predictor_gain_r parameter, and/or cross_color_predictor_gain_s parameter may be signaled in other manners. For example, these parameters may be signaled over a set of index values r, i, and j. In particular, the index values i and j may be signaled such that they only signal matching pairs, [0][0], [1][1], [2][2], while r is signaled over a range of values. Other combinations of signaling may likewise be used, as desired. Other ranges of parameters may likewise be used, as desired. If desired, those combinations that are not expressly signaled (or inferred to be some value) may be inferred to be a predetermined value, such as 0. In this manner, the amount of signaling may be reduced and otherwise reduce the complexity of the system.

Another technique that may be employed to signal the color-prediction parameters corresponding to a color space region r in the bitstream may include the use of color-prediction parameters of a previous color space region, which has already been determined. For example, a color space region A may have color-prediction parameter values that are already determined as T1, T2, T3, and T4 and color space region B may have color-prediction parameters not yet determined as S1, S2, S3, and S4. Then one or more of the color-prediction parameters S1 to S4 of color space region B may be predicted based upon one or more of the color-space prediction parameters T1 to T4 of color space region A. In an exemplary embodiment to signal Tn, Tn-Sn may be signaled in the bitstream, where n corresponds to the color-prediction parameter index.

In some embodiments, the video decoder 500 can scale a resolution of the first image from the first image format into a resolution corresponding to the second image format. For example, the UHDTV video standard can support a 4 k (3840×2160 pixels) or an 8 k (7680×4320 pixels) resolution and a 10 or 12 bit quantization bit-depth. The BT.709 video standard can support a 2 k (1920×1080 pixels) resolution and an 8 or 10 bit quantization bit-depth. The video decoder 500 can scale the decoded first image from a resolution corresponding to the BT.709 video standard into a resolution corresponding to the UHDTV video standard.

At a block 830, the video decoder 500 can generate a color space prediction based, at least in part, on the scaled color space of the first image. The color space prediction can be a prediction of a UHDTV image frame (or portion thereof) from a color space of a corresponding decoded BT.709 image frame. In some embodiments, the video decoder 500 can generate the color space prediction based, at least in part, on the scaled resolution of the first image.

At a block 840, the video decoder 500 can decode the encoded video stream into a second image having the second image format based, at least in part, on the color space prediction. In some embodiments, the video decoder 500 can utilize the color space prediction to combine with a portion of the encoded video stream corresponding to a prediction residue from the video encoder 300. The combination of the color space prediction and the decoded prediction residue can correspond to a decoded UHDTV image frame or portion thereof.

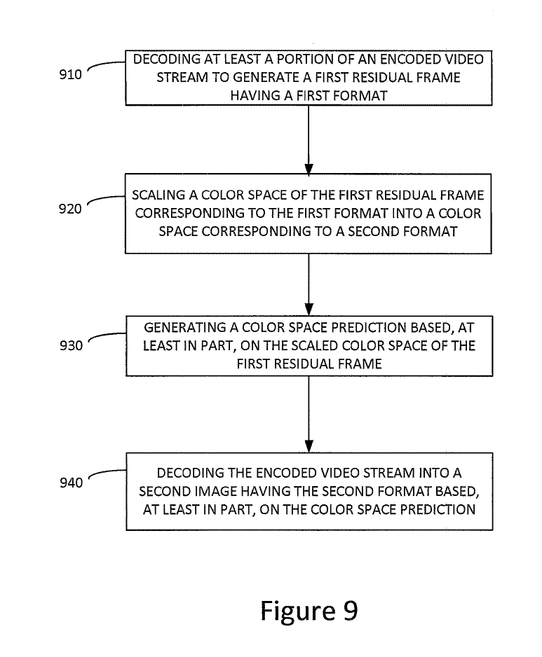

FIG. 9 is another example operational flowchart for color space prediction in the video decoder 500. Referring to FIG. 9, at a first block 910, the video decoder 500 can decode at least a portion of an encoded video stream to generate a first residual frame having a first format. The first residual frame can be a frame of data corresponding to a difference between two image frames. In some embodiments, the first format can correspond to a BT.709 video standard and the video decoder 500 can include a base layer to decode BT.709 image frames.

At a block 920, the video decoder 500 can scale a color space of the first residual frame corresponding to the first format into a color space corresponding to a second format. In some embodiments, the video decoder 500 can scale the color space between the BT.709 video standard and an Ultra High Definition Television (UHDTV) video standard corresponding to the second format.

There are several ways for the video decoder 500 to scale the color space supported by BT.709 video coding standard to a color space supported by the UHDTV video standard, such as independent channel prediction and affine mixed channel prediction. For example, the independent color channel prediction can scale YUV components of the encoded BT.709 image frames separately, for example, as shown above in Equations 1-6. The affine mixed channel prediction can scale YUV components of the encoded BT.709 image frames with a matrix multiplication, for example, as shown above in Equations 7-9.

The video decoder 500 can select a type of color space scaling to perform, such as independent channel prediction or one of the varieties of affine mixed channel prediction based on channel prediction parameters the video decoder 500 receives from the video encoder 300. In some embodiments, the video decoder 500 can perform a default or preset color space scaling of the decoded BT.709 image frames.

In some embodiments, the video decoder 500 can scale a resolution of the first residual frame from the first format into a resolution corresponding to the second format. For example, the UHDTV video standard can support a 4 k (3840×2160 pixels) or an 8 k (7680×4320 pixels) resolution and a 10 or 12 bit quantization bit-depth. The BT.709 video standard can support a 2 k (1920×1080 pixels) resolution and an 8 or 10 bit quantization bit-depth. The video decoder 500 can scale the decoded first residual frame from a resolution corresponding to the BT.709 video standard into a resolution corresponding to the UHDTV video standard.

At a block 930, the video decoder 500 can generate a color space prediction based, at least in part, on the scaled color space of the first residual frame. The color space prediction can be a prediction of a UHDTV image frame (or portion thereof) from a color space of a corresponding decoded BT.709 image frame. In some embodiments, the video decoder 500 can generate the color space prediction based, at least in part, on the scaled resolution of the first residual frame.

At a block 940, the video decoder 500 can decode the encoded video stream into a second image having the second format based, at least in part, on the color space prediction. In some embodiments, the video decoder 500 can utilize the color space prediction to combine with a portion of the encoded video stream corresponding to a prediction residue from the video encoder 300. The combination of the color space prediction and the decoded prediction residue can correspond to a decoded UHDTV image frame or portion thereof.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

One of skill in the art will recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for decoding a bitstream for video by a decoder comprising the steps of:
(a) receiving color parameters within said bitstream;
(b) where said color parameters include a residual coefficient divisor value provided with said bitstream;
(c) where said color parameters include a residual coefficient quotient value provided with said bitstream;
(d) where said color parameters includes a residual coefficient remainder value provided with said bitstream;
(e) where said color parameters include a residual coefficient sign provided with said bitstream, where said residual coefficient sign is signaled only if either said residual coefficient quotient value or said residual coefficient remainder value are non-zero;
(f) decoding said video based upon said residual coefficient divisor value, residual coefficient quotient value, said residual coefficient remainder value, and said residual coefficient sign received in said bitstream.

2. The method of claim 1 wherein color parameters relate to a mapping between different layers of said bitstream.

3. The method of claim 1 wherein if said residual coefficient sign is not signaled it is inferred to be zero.

4. The method of claim 3 wherein said a value of 0 for said residual coefficient sign represents a positive residual coefficient value and a value of 1 for said residual coefficient sign represents a negative residual coefficient value.

5. The method of claim 4 wherein said residual coefficient value is determined by multiplying the said residual coefficient quotient with the said residual coefficient divisor and the result being added to said residual coefficient remainder and the sign being determined based on the value of said residual coefficient sign.

6. The method of claim 1 further comprising receiving a predictor for said color parameters.

7. The method of claim 1 wherein a predictor for said color parameters is inferred based upon data signaled in said bitstream.

8. The method of claim 1 wherein a color parameter value is determined based upon a predictor for said color parameters and said residual coefficient value.

9. The method of claim 7 further comprising decoding said video based upon said color parameter value.

10. The method of claim 5 wherein a color parameter value is determined based upon a predictor for said color parameters and said residual coefficient value.

11. The method of claim 5 further comprising receiving a predictor for said color parameters.

12. The method of claim 5 wherein a predictor for said color parameters is inferred based upon data signaled in said bitstream.
